(19) United States
(12) Patent Application Publication
(10) Pub. No.: US 2024/0340261 A1
(43) Pub. Date: Oct. 10, 2024

(54) COLLATING AND PRESENTING COMMUNICATIONS BASED ON ONE OR MORE CHARACTERISTICS

(71) Applicant: Michael Alan Solovay, Cedar City, UT (US)

(72) Inventor: Michael Alan Solovay, Cedar City, UT (US)

(21) Appl. No.: 18/611,027

(22) Filed: Mar. 20, 2024

Related U.S. Application Data
(60) Provisional application No. 63/457,072, filed on Apr. 4, 2023.

(51) Int. Cl. H04L 51/216; G06F 40/35; H04L 51/08; H04L 51/56

(52) U.S. Cl. CPC H04L 51/216; G06F 40/35; H04L 51/08; H04L 51/56

(57) ABSTRACT

An apparatus for collating and selectively presenting communications includes a processor and a memory storing instructions that, when executed by the processor, cause the apparatus to receive a communication having one or more characteristics and to assign the communication to a collection based on the one or more characteristics. The instructions are further executable by the processor to cause the apparatus to store the collection to a database, where the collection comprising a plurality of communications associated with a plurality of communication types. The instructions are further executable by the processor to cause the apparatus to add metadata to the collection, the metadata linking one or more contacts to the collection and to organize the collection into a communication timeline. The instructions are further executable by the processor to cause the apparatus to present, via an electronic display, at least a portion of the communication timeline to a user.

### CROSS-REFERENCES TO RELATED APPLICATIONS

This application claims the benefit of U.S. Provisional Patent Application No. 63/457,072 entitled “COLLATING AND PRESENTING COMMUNICATIONS BASED ON ONE OR MORE CHARACTERISTICS” and filed on Apr. 4, 2023 for Michael Alan Solovay, which is incorporated herein by reference.

### FIELD

This invention relates to communications and more particularly relates to collating communications related to a common matter and selectively presenting a portion of the collated communications.

### BACKGROUND

When working together on a matter, such as a project, transaction, case, negotiation, proceeding, operation, campaign, etc., the involved individuals communicate with one another via different mediums and may generate a number of files, records, documents, and other information related to the matter. It can be difficult for a user to conceptualize the communication history across the multiple different mediums and to manage the communications and associated information (e.g., files, records, documents, and other information related to the matter). Conventional solutions fail to integrate the different communications and associated information into a user-friendly interface.

### SUMMARY

An apparatus for collating and selectively presenting communications includes a processor and a memory storing instructions that, when executed by the processor, cause the apparatus to receive a communication having one or more characteristics and to assign the communication to a collection based on the one or more characteristics. The instructions are further executable by the processor to cause the apparatus to store the collection to a database, where the collection includes a plurality of communications associated with a plurality of communication types. The instructions are further executable by the processor to cause the apparatus to add metadata to the collection where the metadata links one or more contacts to the collection and to organize the collection into a communication timeline. The instructions are further executable by the processor to cause the apparatus to present, via an electronic display, at least a portion of the communication timeline to a user.

A method for collating and selectively presenting communications includes receiving a communication having one or more characteristics and assigning the communication to a collection based on the one or more characteristics. The method includes storing the collection to a database, where the collection includes a plurality of communications associated with a plurality of communication types. The method includes adding metadata to the collection. The metadata links one or more contacts to the collection. The method includes organizing the collection into a communication timeline and presenting, via an electronic display, at least a portion of the communication timeline to a user.

A program product for collating and selectively presenting communications includes a non-transitory computer readable storage medium storing code. The code is configured to be executable by a processor to perform operations that include receiving a communication having one or more characteristics, assigning the communication to a collection based on the one or more characteristics, and storing the collection to a database. The collection includes a plurality of communications associated with a plurality of communication types. The operations include adding metadata to the collection where the metadata links one or more contacts to the collection, organizing the collection into a communication timeline, and presenting, via an electronic display, at least a portion of the communication timeline to a user.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a diagram illustrating one embodiment of a system for collating and selectively presenting communications;

FIG. 2 is a block diagram illustrating one embodiment of a collection management apparatus;

FIG. 3 is a block diagram illustrating another embodiment of a collection management apparatus;

FIG. 4 is a block diagram illustrating one embodiment of a timeline apparatus;

FIG. 5 is a block diagram illustrating another embodiment of a timeline apparatus;

FIG. 6A is a diagram illustrating one embodiment of outbound call handling in a unified communication network (“UCN”);

FIG. 6B is a diagram illustrating one embodiment of inbound call handling in a UCN;

FIG. 6C is a diagram illustrating another embodiment of outbound call handling in a unified communication network (“UCN”);

FIG. 7A is a diagram illustrating one embodiment of outbound text message handling in a UCN;

FIG. 7B is a diagram illustrating one embodiment of inbound text message handling in a UCN;

FIG. 8A is a diagram illustrating one embodiment of outbound electronic mail (“email”) handling in a UCN;

FIG. 8B is a diagram illustrating one embodiment of inbound email handling in a UCN;

FIG. 9 is a diagram illustrating one embodiment of real-time communication (“RTC”) handling in a UCN;

FIG. 10 is a flowchart diagram illustrating one embodiment of a linking schema for a voice communication;

FIG. 11 is a flowchart diagram illustrating one embodiment of a linking schema for a text message;

FIG. 12 is a flowchart diagram illustrating one embodiment of a linking schema for an email communication;

FIG. 13 is a flowchart diagram illustrating one embodiment of recording preference handling;

FIG. 14A is a diagram illustrating one embodiment of a timeline presentation for a collection of communications;

FIG. 14B is a diagram illustrating a further view of the timeline presentation of FIG. 14A;

FIG. 14C is a diagram illustrating one embodiment of an expanded item in the timeline presentation of FIGS. 14A-14B;

FIG. 15 is a diagram illustrating another embodiment of a timeline presentation for a collection of communications;

FIG. 16 is a diagram illustrating one embodiment of an email archive corresponding to a collection of communications;

FIG. 17 is a diagram illustrating one embodiment of a reporting suite associated with a collection of communications;

FIG. 18 is a diagram illustrating another embodiment of a reporting suite associated with a collection of communications;

FIG. 19 is a diagram illustrating one embodiment of a screenshot with routing codes for text messaging; and

FIG. 20 is a flowchart diagram illustrating one embodiment of a method of collating and selectively presenting communications.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic (“PLA”), programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider (“ISP”)). In some embodiments, electronic circuitry including, for example, programmable logic circuitry, FPGA, or PLAs may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

An apparatus for collating and selectively presenting communications includes a processor and a memory storing instructions that, when executed by the processor, cause the apparatus to receive a communication having one or more characteristics and to assign the communication to a collection based on the one or more characteristics. The instructions are further executable by the processor to cause the apparatus to store the collection to a database, where the collection includes a plurality of communications associated with a plurality of communication types. The instructions are further executable by the processor to cause the apparatus to add metadata to the collection where the metadata links one or more contacts to the collection and to organize the collection into a communication timeline. The instructions are further executable by the processor to cause the apparatus to present, via an electronic display, at least a portion of the communication timeline to a user.

In some embodiments, the operations include applying a machine learning model to perform an emotion analysis of the communication and transmitting a notification to the user based on the emotion analysis. In other embodiments, the operations include applying a machine learning model to perform an emotion analysis of the collection, where presenting, via the electronic display, at least a portion of the communication timeline to the user includes presenting at least one trust indicator based on the emotion analysis of the collection. In other embodiments, presenting, via the electronic display, at least a portion of the communication timeline to the user includes presenting, via the electronic display, an expandable view of each communication in a presented portion of the communication timeline.

In some embodiments, the operations include receiving, via a user interface, one or more comments from the user regarding a respective communication in the presented portion of the communication timeline, storing, in the database, the one or more comments, and adding metadata to the collection linking the one or more comments to the collection. In other embodiments, operations include allocating a set of direct inward dialing (“DID”) numbers to the user. The collection is associated with a particular DID number, and assigning the communication to the collection is based on the communication being associated with the particular DID number. In other embodiments, the particular DID number is shared by a plurality of users.

In some embodiments, the operations include converting a subset of the collection to a set of emails for delivery to a specific email address. In other embodiments, converting the subset of the collection to a set of emails includes identifying a communication type for each communication in the subset, generating an email with each communication in the subset where the email has a subject field, and inserting an identifier corresponding to the respective communication type into the subject field of each generated email. In other embodiments, the operations include adding originator information to each email of the set of emails. In other embodiments, the operations include identifying a communication peer associated with the communication, determining that the communication peer has authorized communication recording, recording the communication, storing the recording to the database, and transmitting the recording of the communication to the user. In other embodiments, the operations include determining a set of routing parameters for each linked contact associated with the collection.

In some embodiments, the operations include determining a preferred communication type for at least one linked contact based on the collection. In other embodiments, assigning the communication to the collection based on the one or more characteristics includes determining whether the communication belongs to an existing collection based on shared characteristics and generating a new collection in response to the communication not belonging to an existing collection. In further embodiments, determining whether the communication belongs to an existing collection includes comparing the one or more characteristics of the communication to one or more characteristics of the existing collection. The characteristics include an identity of the user, a contact associated with the communication, a routing code, or a combination thereof.

In some embodiments, the collection is automatically defined without user input and corresponds to one of: a project, a transaction, a collaboration, or a combination thereof. In other embodiments, the collection includes a plurality of communications, including one or more of: a telephone call, a voice call, a video call, a text message, an email, a Voice over Internet Protocol (“VoIP”) call, a chat session, a real-time communication (“RTC”), or a combination thereof. In other embodiments, presenting, via the electronic display, at least a portion of the communication timeline to a user includes identifying a set of attachments, each attachment associated with a particular communication contained within the collection, and presenting the set of attachments to the user. The set of attachments includes one or more of: a computer file, a document, an image, a video recording, an audio recording, or a combination thereof. In other embodiments, received communication is an inbound communication and the operations include appending collection information to the inbound communication prior to delivery to the user.

A method for collating and selectively presenting communications includes receiving a communication having one or more characteristics and assigning the communication to a collection based on the one or more characteristics. The method includes storing the collection to a database, where the collection includes a plurality of communications associated with a plurality of communication types. The method includes adding metadata to the collection. The metadata links one or more contacts to the collection. The method includes organizing the collection into a communication timeline and presenting, via an electronic display, at least a portion of the communication timeline to a user.

A program product for collating and selectively presenting communications includes a non-transitory computer readable storage medium storing code. The code is configured to be executable by a processor to perform operations that include receiving a communication having one or more characteristics, assigning the communication to a collection based on the one or more characteristics, and storing the collection to a database. The collection includes a plurality of communications associated with a plurality of communication types. The operations include adding metadata to the collection where the metadata links one or more contacts to the collection, organizing the collection into a communication timeline, and presenting, via an electronic display, at least a portion of the communication timeline to a user.

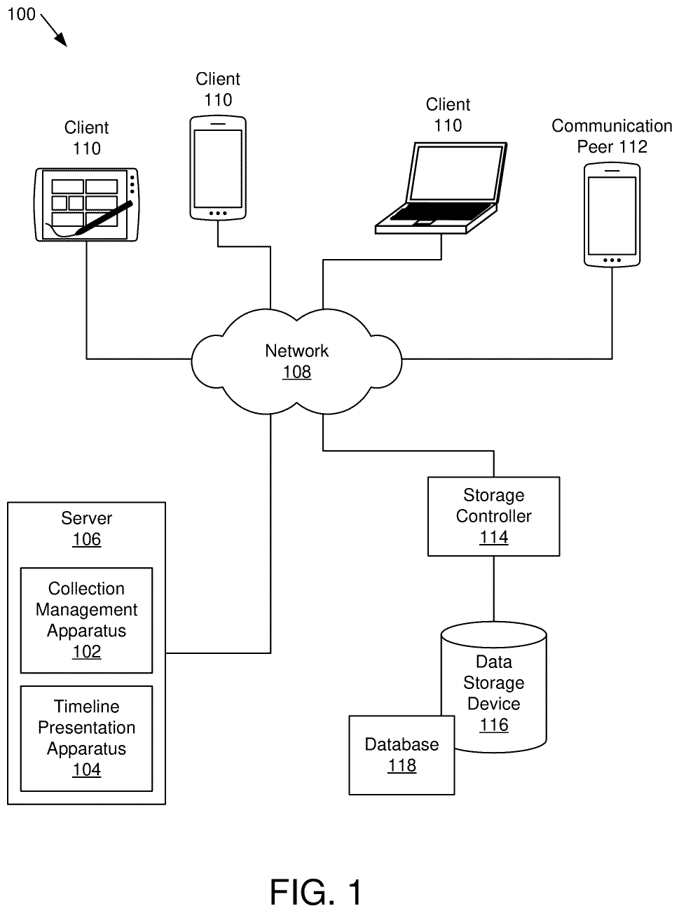

FIG. 1 depicts a system 100 for collating and selectively presenting communications, according to embodiments of the disclosure. The system 100 includes a collection management apparatus 102, a timeline presentation apparatus 104, a server 106 that implements the collection management apparatus 102 and the timeline presentation apparatus 104, a storage controller 114 communicatively coupled to a data storage device 116 which stores at least one database 118, which are described below.

Via the computer network 108, the server 106 may interact with one or more client devices 110 associated with authorized users of the system 100. Additionally, the server 106 may also interact with one or more communication peers 112, which are distinct from the client devices 110. While not depicted in FIG. 1, the system 100 may include—or be coupled to—various telecommunications equipment, such as email servers, RTC servers, Private Branch Exchange (“PBX”) networks, communications servers, routers, switches, gateways, and other network elements and networking devices. Communications may originate from the same or different carriers, networks and service providers and be autonomous to this system 100.

The system 100 is representative of various systems where the embodiments described herein may be deployed. The server 106, in some embodiments, is in a data center and may be a cloud implementation. For example, the server 106 may be leased and the collection management apparatus 102 and the timeline presentation apparatus 104 may be implemented in one or more virtual machines, containers, or the like. In other embodiments, the server 106 is user-owned and the collection management apparatus 102 and the timeline presentation apparatus 104 are implemented thereon. While a single server 106 is depicted, one of skill in the art will recognize that the collection management apparatus 102 and the timeline presentation apparatus 104 may be deployed on multiple servers 106 for ease of deployment, for redundancy, etc.

The server 106 may be a rack-mounted server, a workstation, a mainframe computer, a desktop server, a laptop server, and the like or any combination thereof. The server 106 includes one or more processors, memory, data buses, access to non-volatile data storage, input/output connections, and the like. One of skill in the art will recognize other implementations of a server 106 capable of executing the collection management apparatus 102 and the timeline presentation apparatus 104.

The client devices 110 are depicted as a tablet computer a smartphone, and a laptop computer as examples but may be implemented by a workstation, a desktop computer, a terminal, or other computing device capable of connection to the server 106 over the computer network 108. In some embodiments, a client device 110 is used by a system administrator for installation, maintenance, control, etc. of the collection management apparatus 102 and the timeline presentation apparatus 104. In other embodiments, the client devices 110 are user devices for using the collection management apparatus 102 and/or the timeline presentation apparatus 104. For example, a user may use a smartphone as a client device 110 to interact with the collection management apparatus 102 and/or the timeline presentation apparatus 104.

The computer network 108 connects the client devices 110 to the server 106 to access the collection management apparatus 102 and/or the timeline presentation apparatus 104 and may also be used to access the data storage device 116. The computer network 108 includes one or more networks. For example, the computer network 108 may include a LAN and may include a gateway to the Internet. The computer network 108 network may include cabling, optical fiber, etc. and may also include a wireless connection and may include a combination of network types. The computer network 108 may include a LAN, a WAN, a storage area network (“SAN”), an optical fiber network, etc. Various computer networks that are part of the depicted computer network 108 may be private and/or public, for example, through an Internet Service Provider.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM”®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDAR”). Alternatively, the wireless connection may be a cellular telephone network communication. All standards and/or connection types include the latest version and revision of the standard and/or connection type as of the filing date of this application.

The system 100 is depicted with a storage controller 114 with a data storage device 116. In some embodiments, the storage controller 114 and the data storage device 116 are part of a SAN that is accessible to the server 106 and/or to the client devices 110. Access to the data storage device 116 by client device 110 may be indirect for typical users while a system administrator may have direct access to the data storage device 116 through the SAN or through the server 106. The data storage device 116 is depicted as a single data storage device but may include multiple devices. For example, the data storage device 116 may be accessed as one or more virtual storage devices and the data storage device 116 may be implemented with multiple data storage devices (e.g., computer readable storage media) deployed using a redundant array of independent devices (“RAID”) or the like. In other embodiments, the server 106 may include internal non-volatile data storage in addition to or in place of the data storage device 116 and storage controller 114. One of skill in the art will recognize other ways to implement non-volatile data storage, a server 106, etc. to implement the collection management apparatus 102 and the timeline presentation apparatus 104.

In various embodiments, the collection management apparatus 102 includes a way to receive communications, a way to assign (or link) communications to a collection, a way to store collections to the database 118, and a way to link contacts, clients, and/or authorized users to one or more collections. The collection management apparatus 102 receives a new communication having one or more characteristics and then assigns the communication to a new or existing collection based on the one or more characteristics. For example, the new communication may be a telephone call (or recording thereof), a voice call (or recording thereof), a video call (or recording thereof), a text message, an email, a Voice over Internet Protocol (“VoIP”) call (or recording thereof), a chat session (or recording thereof), an RTC session (or recording thereof), or the like.

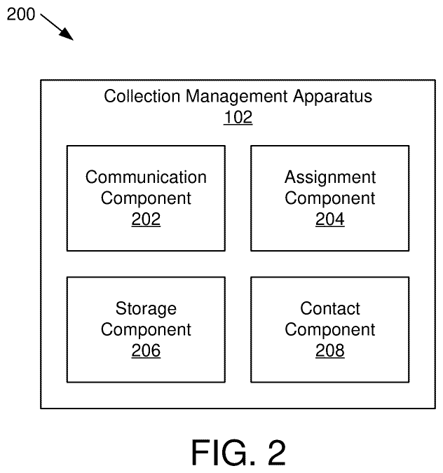

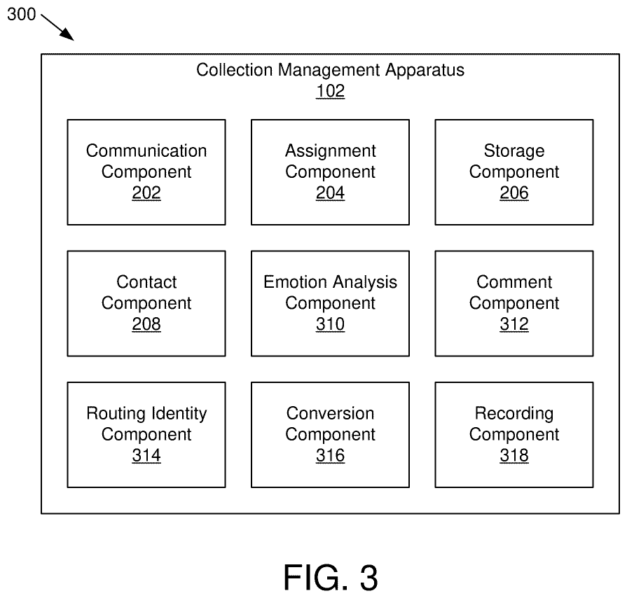

The collection management apparatus 102 also stores the collection (i.e., containing the new communication) to the database 118 and adds metadata to the collection, said metadata linking one or more contacts (including clients and/or authorized users) to the collection. Here, the contact may be associated with the communication peer 112. Note that the collection may include multiple communications corresponding to one or multiple communication types, or to one or multiple communication channels (e.g., voice/video calls, text messages, chat session, emails, video, blog posts, social media posts, etc.). The collection management apparatus 102 is described in more detail below in relation to FIGS. 2 and 3.

The collection assignment is ideal for transactions, projects, files, cases, negotiations, proceedings, programs, operations, campaigns, records, assignments, deals, topics, ventures, or enterprises. In one embodiment, each created collection is named, e.g., by a system user or automatically generated by the collection management apparatus 102. Here, a “system user” refers to a user authorized to access and utilize an instance of the server 106. As such, a system user may have an account with the server 106 or a service provider associated with the server 106.

Additionally, contact(s) or contact groups that have been added into a system user's account (manually or by automation) may be selected and linked to one or more collections by the system user. In some embodiments, the server 106 may issue the contacts (or contact groups) with credentials for communicating with a system user (i.e., who has already received credentials). Examples of credentials for communicating with a system user include, but are not limited to, a direct inward dialing (“DID”) number (e.g., a local or toll-free telephone number), an email address, and the like.

In some embodiments, the DID numbers issued for voice and text messages are not unique for every collection nor for every contact. Furthermore, blocks of system users may share a particular DID number. However, the server 106 may be configured to distribute DID numbers and avoid system users sharing contacts to ensure contact communications are properly routed and linked to their intended system user's account.

In some embodiments, the email address assignment is unique to each system user and each email is system encoded (e.g., To, From, Subject, Message-ID, and Body headers) to ensure its associated collection and contact can be matched at the time the email is saved to the database 118.

In some embodiments, the linking of the collection to each voice and text message communication entered into the database can be performed for voice via a PBX Interactive voice response (“IVR”) (e.g., using voice or keypad as input). In certain embodiments, the linking of a text message to the collection may use a routing code. In certain embodiments, the linking of both voice and text communications to a collection is performed by automatic assignment using a computer algorithm (such as machine learning model, natural language model, an artificial intelligence model, cognitive model, or the like). In other embodiments, the linking of both voice and text communications to a collection is performed by manual assignment before the communication occurs, e.g., by using a system application (not depicted in FIG. 1) running on a client device 110 that interacts with the server 106. In various embodiments, the system application allows manual assignment (or reassignment) of all supported communications. In one embodiment, the system application is a browser-based application accessed via the client device 110. In another embodiment, the system application is a standalone application (e.g., executable program) installed on the client device 110.

In some embodiments, the above collection linking options are determined by system configuration. In certain embodiments, a system user may override a configured collection linking option via the system application. In other words, configuration options input via the system application may supersede other system configurations.

In certain embodiments, the system application may be used for video calls, chat, and other shared peer-to-peer(s) Internet Protocol (“IP”) driven communications. In other embodiments, third-party supported applications may be used for video calls, chat, and other shared peer-to-peer(s) IP driven communications. Note that it is not necessary that users communicate with each other, for example engaged in a transaction, to use this system application, e.g., for voice calls, email, and text messaging.

In some embodiments, a communication may explicitly declare the collection to which the communication should be linked. In other embodiments, the associated collection may not be explicitly declared in a communication. In such embodiments, when the contact is typically only linked to one active collection, then the collection management apparatus 102 may be configured to automatically link the communication to a particular collection (i.e., automatic assignment without user input). Relatedly, when it is a priority to expedite the routing of the communication for which the collection is not explicitly declared (e.g., to provide the most seamless experience), then the server 106 may be configured to automatically link the communication to a particular collection (i.e., automatic assignment without user input). In such embodiments, a notification may be sent to a system user associated with the collection or communication that allows for manual reassignment of the communication.

However, for situations where a contact is typically linked to two or more active collections and the system application is not used to send/receive the communication for which the collection is not explicitly declared, then the collection management apparatus 102 may prioritize manual assignment (e.g., using IVR, keypad- or voice-input, etc.) of the communication. In certain embodiments, the database may store a set of one or more communications awaiting manual assignment.

When multiple routing settings are defined to establish when the automatic assignment (e.g., by computer algorithm) versus manual assignment (e.g., by a system user) is to be employed by the collection management apparatus 102, then a contact type designation may be applied and used as a criterion when determining whether to employ automatic or manual assignment. Example contact types include, business-to-business (“B2B”), business-to-consumer (“B2C”), consumer-to-consumer (“C2C”), and internal communication (“IC”). Accordingly, the selected communication routing parameters may be based at least in part on the contact type, and the communication routing parameters may be further customized according to the contact type.

Examples of communication types and/or communication channels that can be captured, recorded, archived, and/or collated and then linked to the collection include (but are not limited to): voice calls (e.g., from mobile, satellite, landline, VoIP), video calls, text messages, chat (e.g., instant messaging), email and any associated attachments (i.e., files, images, documents, video, audio and other transferable data and content), social media posts and related responses, and other IP driven formats.

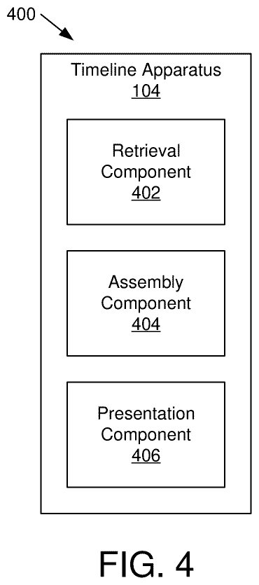

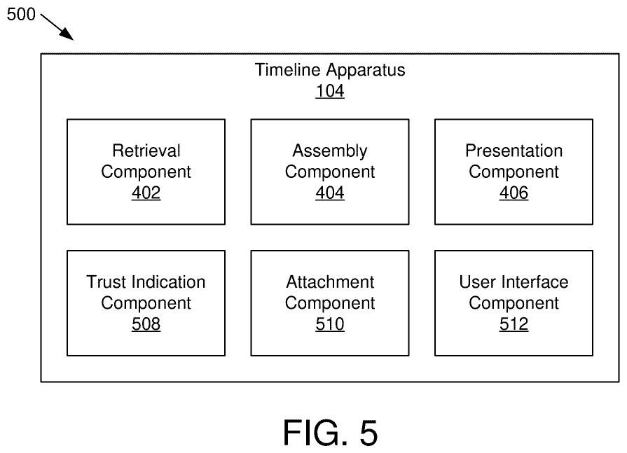

The timeline presentation apparatus 104 organizes a collection into a communication timeline and then presents at least a portion of the communication timeline to a user. In some embodiments, the timeline presentation apparatus 104 may sort and/or filter the collection to generate the presented portion of the communication timeline. The timeline presentation apparatus 104 is described in more detail below in relation to FIGS. 4 and 5.

In various embodiments, the communications of a collection may be retrievable via the system application. In some embodiments, at least a portion of the communication of the collection may be itemized in a communication timeline that can be sorted, e.g., by a specific category/type or by most recent communications that contain all categories/types.

In some embodiments, an itemized communication associated with a desired collection may be selected (e.g., clicked on) to sort the communication timeline by only that associated collection. In some embodiments, the system application may provide a menu (or other user interface element) used to sort communications by collection.

In various embodiments, each itemized communication contains information like collection, contact, communication type, date, priority, attachment quantity, attachments, message information, notes, comments and flags. In various embodiments, an itemized communication may be abridged (e.g., displaying only a synopsis of the communication), whereby selecting (e.g., clicking on) the abridged communication would expand the itemized communication by loading additional information from the database.

In various embodiments, the timeline presentation apparatus 104 may include functionality like adding comments, notes, or a flag to an itemized communication. Additionally, the timeline presentation apparatus 104 may then save this information to the database 118 and append the saved information to the itemized communication it pertains to. In various embodiments, all the communications of a collection stored in the database 118 are sortable and searchable.

In various embodiments, one or more collections may be nested into another collection, e.g., where the top level categorical collection is representative of a master collection. In certain embodiments, this master collection might keep its existing and original naming schema, or it could be renamed, or a new collection name (e.g., a virtual collection in nature that is empty and void of communications) used for categorical hierarchy purposes only could be created, and then both new and existing collections could be added, that may become available from this master collection.

In some embodiments, these nested collections (or subcategories to the main category, considered the master collection), may be made visible in the master collection, e.g., by clicking on their nested collection name by text, or graphic (such as a text link, image, icon or folder) in order to display these nested communications from within the master collection.

For example, an aerospace company may have 25 projects, e.g., named Project 1 through Project 25. In certain embodiments, the aerospace company may create a new master collection having a placeholder name (e.g., Project A), where Projects 1-25 are available in the communication timeline. Suppose at a later date that Projects 1-25 have been completed, and now active Projects 26-30 are added into the master collection (e.g., Project A). While these Projects 1-30 are available as independent collections in their own timelines, in addition, all these projects may also be accessed from the master collection called Project A. While in this example Project A was a placeholder, this same principle applies if Project A was an existing collection that contained an array of archived communications.

Note that with the nested collection there is no duplication of communications for this process. Rather, using nested collection is simply a case of creating and/or defining a master collection in a database table (e.g., a table called “Master Collection Category”) that may be an existing collection, or virtual in nature like a placeholder. Then another database table (e.g., a table called “Master Collection Subcategory”) may contain the unique ID of the Master Collection Category.

In this schema, each time a nested collection is added to the Master Collection, e.g., by GUI (such as via a user or administrative control panel), an itemized entry may be created as a subcategory using this nested collections unique ID, and the unique ID of the collection added. In some embodiments, the option exists to define one of these subcategories to be displayed in the Master Collection as the primary and default collection, for example when the Master Collection is a placeholder, i.e., virtual in nature. In some embodiments, when one of these subcategories is removed, its entry is deleted from the database.

In various embodiments, permissions may be assigned where authorized users may only have access to various nested collections or certain communication parameters. These permissions may be identified and regulated by a contact's assigned contact type that could be by department, and also further distinguishable by type of position, e.g., manager, employee or contractor, as contact types may contain nested levels. Additionally, permission may be assigned to an entire contact group. For example, there may be a contact group called “test engineers,” and this contact group might only have access to Projects 13 and 26-27. In certain embodiments, the access of this contact group may be regulated by communication type, such that they only have access to emails. In certain embodiments, the access of this contact group may be further regulated by other predefined parameters like by date, particular sender(s) of communications, only those containing attachments, etc.

FIG. 2 depicts one embodiment of an apparatus 200 for collating communications of various types, according to embodiments of the disclosure. The apparatus 200 includes one embodiment of the collection management apparatus 102 that includes a communication component 202, an assignment component 204, a storage component 206, and a contact component 208, which are described below.

Note that the components 202-208 may include any component or set of components that perform the functionality attributed to the component. This may include one or more physical processors which execute processor-readable instructions, the processor-readable instructions (e.g., as software application or other executable), circuitry, computer hardware, storage media, some combination of software, hardware, and/or firmware, or any other components. The description of the functionality provided by the different components 202, 204, 206, and/or 208 described below is for illustrative purposes, and is not intended to be limiting, as any of components 202, 204, 206, and/or 208 may provide more or less functionality than is described. For example, one or more of components 202, 204, 206, and/or 208 may be eliminated, and some or all of its functionality may be provided by other ones of components 202, 204, 206, and/or 208. As another example, the apparatus 200 may comprise additional components that may perform some or all of the functionality attributed below to one or more of the components 202, 204, 206, and/or 208.

The apparatus 200 includes a communication component 202 configured to receive a communication (e.g., new communication) having one or more characteristics. Said characteristics may include, but are not limited to, a communication type (e.g., voice/video call, text message, chat session, etc.), an originating telephone number, a terminating telephone number, a Session Initiation Protocol (“SIP”) message type, a SIP header, an email header (e.g., including email addresses of sender and recipient, email subject), a Short Message Service (“SMS”) header, a Multimedia Messaging Service (“MMS”) header, a message body (e.g., of an email or text message), a timestamp, a message identifier, or the like.

In various embodiments, the communication component 202 may identify one or more authorized users associated with the communication. As used herein, an authorized user refers to a user having authority to access and utilize the collection management apparatus 102. For example, an authorized user may have an account (i.e., associated with access credentials) with a service provider that deploys an instance of the collection management apparatus 102. As another example, the authorized user may have a token granting access to an instance of the collection management apparatus 102. In yet another example, the authorized user may be the owner of a device utilizing an instance of the collection management apparatus 102.

The apparatus 200 includes an assignment component 204 configured to assign the communication to a collection, e.g., based on the one or more characteristics. In various embodiments, assigning the communication to the collection based on the one or more characteristics includes determining whether the communication belongs to an existing collection based on shared characteristics. In some embodiments, determining whether the communication belongs to an existing collection comprises comparing the one or more characteristics of the communication to one or more characteristics of the existing collection. In addition to the above example characteristics, the compared characteristics may include an identity of a user, a contact associated with the communication, a routing code, or a combination thereof.

Where the comparison does not identify an existing collection, the assignment component 204 may trigger the generating of a new collection (i.e., in response to the communication not belonging to any existing collection). In certain embodiments, the assignment component 204 may automatically generate the new collection (or trigger its generation by another component or module coupled to the collection management apparatus 102) when the characteristics of the communication do not match any existing collection. In other embodiments, the assignment component 204 may trigger manual review and/or generation of the new collection when the characteristics of the communication do not match any existing collection. In certain embodiments, each collection may have an owner and/or a primary user, where the owner/primary user performs the manual review and/or receives notification relating to the collection.

The apparatus 200 includes a storage component 206 configured to store the collection to a database. In various embodiments, the collection may include multiple communications associated with different communication types or different communication channels. For example, the collection may include phone calls (i.e., call records and/or recordings), emails, and chat session logs relating to a common task, project, collaboration, transaction, or similar activity. The storage component 206 may interact with the storage controller 114 to store communications in the database 118 and associate the communications with a particular collection. In certain embodiments, the storage component also interacts with the storage controller to store additional information relating to a respective collection, such as notes, comments, attachments, metadata, etc.

The apparatus 200 includes a contact component 208 configured to link one or more contacts to a particular collection. In various embodiments, the contact component adds metadata to the particular collection, the metadata linking the one or more contacts to the particular collection. Here, the one or more contacts may include individuals and/or organizations that communicate and/or interact with the owner or primary user of the collection.

In some embodiments, the contact component 208 may automatically associate a new contact with the collection when a communication involving the new contact is added to the collection. In certain embodiments, the owner/primary user may authorize the contact component 208 to import contact information, e.g., from a device, database, contact list, and/or contact management system associated with the owner/primary user. In some embodiments, the contact component 208 may analyze the collection to determine a preferred communication type for at least one linked contact based on the collection contents.

FIG. 3 depicts another embodiment of an apparatus 300 for collating communications of various types, according to embodiments of the disclosure. The apparatus 300 includes another embodiment of the collection management apparatus 102 that includes a communication component 202, an assignment component 204, a storage component 206, and a contact component 208 that are substantially similar to those described above in relation to the apparatus 200 of FIG. 2. In various embodiments, the embodiment of the collection management apparatus 102 additionally includes an emotion analysis component 310, a comment component 312, a routing identity component 314, a conversion component 316, and a recording component 318, which are described below.

Note that the components 310-318 may include any component or set of components that perform the functionality attributed to the component. This may include one or more physical processors which execute processor-readable instructions, the processor-readable instructions (e.g., as software application or other executable), circuitry, computer hardware, storage media, some combination of software, hardware, and/or firmware, or any other components. The description of the functionality provided by the different components 310, 312, 314, 316, and/or 318 described below is for illustrative purposes, and is not intended to be limiting, as any of components 310, 312, 314, 316, and/or 318 may provide more or less functionality than is described. For example, one or more of components 310, 312, 314, 316, and/or 318 may be eliminated, and some or all of its functionality may be provided by other ones of components 310, 312, 314, 316, and/or 318. As another example, the apparatus 300 may comprise additional components that may perform some or all of the functionality attributed below to one or more of the components 310, 312, 314, 316, and/or 318.

The apparatus 300 includes an emotion analysis component 310 configured to apply a machine learning model to perform an emotion analysis of the communication and transmitting a notification to the user based on the emotion analysis. For example, the emotion analysis component 310 may identify possible problems or negative emotions present in a particular communication. Alternatively, the emotion analysis component 310 may identify possible trust indicators or positive emotions present in a particular communication. In some embodiments, the emotion analysis component 310 may evaluate the various emotional cues present in a communication to generate a notification (e.g., report) to, e.g., the primary user associated with the collection to which the communication belongs.

In various embodiments, the emotion analysis component 310 applies a computer algorithm (such as machine learning model, natural language model, an artificial intelligence model, cognitive model, or the like) to perform an emotion analysis of the entire collection. The emotion analysis component 310 may identify emotion trends from the collection, such as increasing (or decreasing) trust, excitement, hesitation, etc. Moreover, the emotion analysis component 310, e.g., in conjunction with the storage component 206, may add a result of the emotional analysis to the collection, e.g., as metadata, or as a document or file associated with the collection.

The apparatus 300 includes a comment component 312 configured to receive (e.g., via a user interface) user comments, notes, explanations, and the like regarding a respective communication belonging to a collection. In certain embodiments, the comments/notes are received in relation to a presented portion of the communication timeline. For example, the user may see the respective communication and input a comment or note associated with the communication.

Moreover, the comment component 312, e.g., in conjunction with the storage component 206, may add the user comments, notes, explanations, etc. to the collection, e.g., as metadata, or as a document or file associated with the collection. Accordingly, the user comments, notes, explanations, etc. may be stored in the database 118 and may be a part of or linked to the collection.

The apparatus 300 includes a routing identity component 314 configured to determine a set of one or more routing parameters for each linked contact associated with the collection. Here, the routing parameters may include time of delivery, communication type, and corresponding contact information (e.g., phone number, email address, etc.).

In some embodiments, a set of DID numbers may be allocated to a primary user of the collection, and a particular collection may be associated with a particular DID number. Further, the particular DID number may be shared among multiple users that are not associated with the same collection. In other words, there may be a one-to-many association between DID number and users, and also a one-to-many association between DID number and collections. Here, the routing identity component 314, e.g., in conjunction with the communication component 202, may identify the appropriate collection for a communication associated with the particular DID number.

Note that DID numbers are virtual numbers that allow a user to route calls to existing telephone lines. DID numbers were developed in order to be able to assign specific individuals a direct number, without requiring multiple physical phone lines. However, DID numbers may be expensive to acquire, therefore the same DID number may be shared among multiple users.

In various embodiments, the collection management apparatus 102 may use methodology to reduce DID number assignment (e.g., of local or toll-free telephone number) to system users for voice calls and text messaging by employing a much smaller batch of DID numbers than typical. In some embodiments, the collection management apparatus 102 may segregate (e.g., shuffle) system users to different DID numbers based on geo-location, horizontal and vertical, job description, title, area codes, current shared contacts and related data to create uniqueness without requiring a 1:1 DID number ratio as common.

For example, a 200:1 ratio may be employed requiring only 5,000 DID numbers for a million system users as opposed to a million DID numbers needed to be distributed to each individual system user. This represents a huge cost savings when DID numbers are leased and can avoid potential issues that can arise from availability. In certain embodiments, system users likely to share contacts (e.g., at present or in the future) are flagged so as not to allow sharing of a DID number. Thus, by minimizing the likelihood of a non-unique combination of DID number and contact, the collection management apparatus 102 mitigates the risk of a communication being assigned to the wrong collection.

In various embodiments, the routing identify component 314 may identify a routing code for a collection, where the routing code associated a communication with a particular collection. A text messaging routing code schema allows system users (and their contacts that are linked to multiple active collections, e.g., all using one DID number) to use their native text application as the routing code identifies the recipient (e.g., a system user) and the collection identifier (“ID”) the text message is intended for.

A sample routing code might look like (recipient@#transaction): 0901@#2299. In certain embodiments, the routing code precedes the message. An example communication containing a routing code is as follows: “0901@#2299 Thanks I got the docs.”

Depending on system configuration, for example in real estate transactions, the routing identify component 314 may automatically and programmatically routes text messages for clients (i.e., B2C contacts) from their native or third-party application without the need for routing codes to provide a seamless experience. In contrast, a B2B contact linked to two or more active collections may need a routing code.

In some embodiments, the routing code may provide an additional security layer to prevent fraudulent text messages as this DID number being used is also cross referenced to the system user and contact in correlation to the routing code. In such embodiments, when a routing code is incorrect or not included, then the routing identify component 314 may automatically act as an automated assistant and replies back to the sender to verify the routing code.

In certain embodiments, the routing identify component 314 may additionally provide an itemized directory of their collections and available contacts and associated routing codes, assuming the contact is system authorized. This can be advantageous for messaging when discussing multiple collections, as selecting collections in discussion may be faster than applying routing codes.

In certain embodiments, a hyperlink may be appended to each text message allowing a contact to click it and jump from their native text application to a browser-based text message application for creating/sending text messages. Alternatively, the hyperlink may jump to the system application for creating/sending text messages. In certain embodiments, no routing code is ever required when sending SMS or MMS from the system application. Also, the routing code assigned may be different and unique for the system user and any contact that requires it.

The apparatus 300 includes a conversion component 316 configured to convert at least a part of the collection (i.e., the entirety or a subset of the collection) to a set of one or more emails for delivery to a specific email address. In certain embodiments, the specific email address belongs to the owner or primary user of the collection. To convert the collection (or subset thereof) to a set of, i.e., one or more emails, the conversion component 316 may be configured to identify a communication type for each communication in the collection (or subset thereof), generate an email comprising each communication (the email having a subject field), and insert an identifier corresponding to the respective communication type into the subject field of each generated email. In certain embodiments, the conversion component 316 may be further configured to add originator information to each email of the set of one or more emails.

In various embodiments, all communications—regardless of type—may be converted by the conversion component 316 to an email friendly format for bulk delivery (e.g., an itemized communication data dump) and then sent to any email address, e.g., an email address of the owner or primary user of the collection. All these communications bulk delivered could also be dragged, moved, or copied into a dedicated folder named after the collection, once delivered, or a rule or filter can be created in the email application that identifies inbound email messages/communications based on the from address header and/or the subject header to automate the routing and delivery of messages that belong to a collection, into the appropriate folder associated with the collection.

In some embodiments, these communications may be sent by date ascending or descending—regardless of their communication type. Alternatively, these communications may be sorted by communication type, then by date order, by contact and related options.

In various embodiments, sorting or searching the email archive can then collate all or some communications regardless of type within an email application. So, if a user searched this “Transaction #1 [Text]” every text message from Transaction #1 would be returned in their search results.

For email distribution, an icon (like UTF-8) may be added to the subject as a communication type identifier for visually identifying and searching by collection or category name. If multiple collections are being exported, then this identifier might supersede the other secondary sorting just explained.

As an example, assume an email archive contains four different emails with four unique subject headers representing four different archived communication types all from the same transaction (e.g., Transaction #1). Here, the subject lines (with UTF-8 icon) for the archived emails may read as follows: [symbol] Transaction #1 [Text]| [symbol] Transaction #1 [Voice Call]| [symbol] Transaction #1 [Video Call]| [symbol] Transaction #1 [Email]

In some embodiments, the original contact or contact group that generated the communication may be added to the email FROM: header. Additionally, text indicating the contact or contact group that generated the communication (containing the contact names) may also be appended into the email body.

Moreover, the collection management apparatus 102 may append information and data to all communication types sent or received by it as they are all processed prior to being relayed/delivered to their final destination. In various embodiments, when the collection management apparatus 102 identifies a collection and when communications are delivered, the collection information is appended to it.

For example, in regards to text messages and emails, prior to being relayed, useful information pertaining to a collection—like a project name or transaction name—may be added to the subject or body. Some text messaging applications allow for a subject to be declared, and so the collection may be added to the text message subject. While with other text messaging applications, the collection information would see this appended in the body of the message. For emails, the collection information may be added to both the subject and also to the body.

By consistently appending the transaction name to the subject (when necessary if it is not already present), the collection management apparatus 102 enhances a system user's experience processing all communications within their communication timeline. For example, consider the following example text message sent to a subscriber:

Hi, Bob. Got it Thanks.

If text message was sent to a DID, where it could encompass many collections, there may not be a way to connect this to the collection, thus the need to append the collection information to the text. An example of an enhanced text message delivered to the subscriber:

Hi, Bob. Got it Thanks.
Re: 456 Mac St. #225, Micha CA 91317 | MLS# 12399
From: John Smith
Company: Ace Realty

Moreover, if a transaction is defined by the system user as “456 Mac St. #225, Micha CA 91317|MLS #12399”, and the system were to receive a reply from a contact where the subject said: “Re: 456 Mac St. #225, Micha CA 91317|MLS #12399”, it would be converted back to: “456 Mac St. #225, Micha CA 91317|MLS #12399”, removing the “Re:” in order to maintain uniformity.

In certain embodiments, an email issued to a contact group may also have the name of the group as assigned by the system user appended to the From: Header (i.e., A1 Lender Group) and may have the recipients of this group also added into the body of the email. Note that while this appending process is performed for email, it is not typically done for text messaging, especially as they both pertain to a collection structure. While not all text messaging systems support passing a subject using MMS protocol, when applicable the collection could be added to the Subject, and when not applicable it can be appended to the message body or both.

In some embodiments, when a system user is using a device-native text application (i.e., not the system application described above) and because the system user is assigned a public DID number that funnels multiple contact's text messages, there is a possibility for text messages to be scattered and/or associated with a multitude of collections. However, appending the collection information (e.g., transaction name), to the text message allows for quick identification (e.g., by user or collection management apparatus 102) of both the contact and the collection the message applies to.

Moreover, appending the collection information to a text message also simplifies searching through text messages, e.g., using the device-native text message application, where all communications delivered by this system—regardless of collection or contact—would appear under one phone number.

While there may be more than one DID number assigned to a systems user, for example the system user may have one for B2C-related communications/transactions and one for B2B-relates communications/transactions, there are still a multitude of texts from different contacts that pertain to different collection being received into both DID numbers assigned to the same user.

The apparatus 300 includes a recording component 318 configured to determine a recording preference for participants of a real-time communication (e.g., voice or video call) and, if authorized/approved, record the communication. For example, the recording component 318 may be configured to identify a communication peer associated with the communication and search the database 118 to determine whether the communication peer has authorized communication recording. In certain embodiments, the recording component 318 may be configured to transmitting the recording of the communication to a participant, e.g., the owner or primary user of a collection to which the communication belongs. In some embodiments, the recording component 318, in conjunction with the storage component 206, may store the recording to the database 118, e.g., as part of the collection to which the communication belongs.

In some embodiments, contacts calling into the system using a DID number (local or toll-free) assigned to a system user, may set their recording preference to be saved to the database. In certain embodiments, the recording preference may be indicated by keypad or voice command through the PBX IVR. In another embodiment, the recording preference may be indicated by using approval hyperlinks in a welcome email or text message, where the approval hyperlinks take the contact to a webpage or website for granting recording permission. In further embodiments, the recording preference may be previously indicated by written consent and entered manually by a system user and/or authorized staff. This applies to both granting and denying recording permission.

In certain embodiments, having received a recording preference, the contact's preference is then saved to the database 118 and automatically recalled per subsequent call by the PBX. In certain embodiments, in the event a caller hangs up prior to setting their preferences, this process will automatically be initiated when the same caller calls again.

In some embodiments, the ability to set a recording preference is only available for certain callers/contacts. In one example, in a system configuration pertaining to a real estate transaction, this option to allow a contact to set recording preferences would likely only be available for a system user's business to consumer contact (i.e., a client). For other contacts, like service providers designated as B2B, they would experience a mandatory recording prompt “This call may be recorded . . . ” every time they call.

In some embodiments, recording permission is not needed from the contact/caller for certain locations/jurisdictions. For example, there are some states with so called “one-party consent” rules regarding recording permission—where only the subscriber using the system (e.g., system user) needs to give permission to allow recording. When such subscriber has already and always granted recording permission (e.g., by subscribing and agreeing to the terms), no additional permission may need to be granted by the inbound contact caller, assuming the subscriber/system user has not set the recording preference (e.g., manually) to not record the call.

In some embodiments, qualified callers (e.g., as assigned by system configuration) may receive an automatic email copy or text message containing their recorded voice conversation at calls end. For example, using the contact information saved by a system user, this delivery process may occur automatically at calls end—assuming recording permissions are granted. This call's copy can include an audio file (e.g., MP3) and/or a text transcription.

For example, in the case of a real estate transaction, this functionality may incentivize a B2C contact to accept the recording process (and thus receive a copy of the recording), whereas a B2B contact may already have incentive to want the recordings because the recordings may help with their record maintenance and risk mitigation efforts.

In certain embodiments, the collection management apparatus 102 supports customizable communication preferences for staff and team members granting permissions to receive automatic copies of communications. For example, by setting preference in an admin or control panel, staff/team member ‘John Doe’ receives only copies of emails for every transaction, while staff/team member ‘Jane Smith’ receives copies of voice calls (e.g., whereby the audio file and text transcription are delivered to her email) and she also receives a copy of all text messages (e.g., including system alerts).

In some embodiments, the contact type may be used for granting permissions for recording, and in certain embodiments the permissions may be nested. For example, for an IC contact type, a first contact who is in management may be automatically granted permission to access recordings of a second contact in a team or department managed by the first contact. As another example, a first contact who is an employee with certain level of clearance may be automatically granted permission to access recordings of a second contact in an engineering team. Additionally, these contact types could still affect the recording process. For example, certain contact types may be automatically considered to have granted permission to create a recording of a communication.

In some embodiments, designating the contact type may be used to assign different access levels to archived communications and other functionality like access to reporting like trust ratings, and contact type could also be applied to a contact group or to collaborating contact groups. In cases of more complex or nested contact types this could also affect communication routing. Moreover, while several examples described herein relate to transactions involving B2B and/or B2C contacts, the present invention is also applicable to a system configuration for larger project-based organizations, such as an aerospace company.

FIG. 4 depicts one embodiment of an apparatus 400 for presenting collated communications of various types, according to embodiments of the disclosure. The apparatus 400 includes one embodiment of the timeline presentation apparatus 104 that includes a retrieval component 402, an assembly component 404, and a presentation component 406, which are described below.

Note that the components 402-406 may include any component or set of components that perform the functionality attributed to the component. This may include one or more physical processors which execute processor-readable instructions, the processor-readable instructions (e.g., as software application or other executable), circuitry, computer hardware, storage media, some combination of software, hardware, and/or firmware, or any other components. The description of the functionality provided by the different components 402, 404, and/or 406 described below is for illustrative purposes, and is not intended to be limiting, as any of components 402, 404, and/or 406 may provide more or less functionality than is described. For example, one or more of components 402, 404, and/or 406 may be eliminated, and some or all of its functionality may be provided by other ones of components 402, 404, and/or 406. As another example, the apparatus 400 may comprise additional components that may perform some or all of the functionality attributed below to one or more of the components 402, 404, and/or 406.

The apparatus 400 includes a retrieval component 402 configured to retrieve a collection from a data storage device 116. For example, the retrieval component 402 may access the database 118 to retrieve a particular collection of communications. In certain embodiments, the retrieval component 402 is configured to retrieve only a subset of the collection. For example, the retrieval component 402 may filter the collection and retrieve only those items in the collection that match a certain communication type and/or file type. As another example, the retrieval component 402 is configured to a retrieve only those items in the collection that match a certain window of time.

The apparatus 400 includes an assembly component 404 configured to organize the retrieved collection into a communication timeline. In some embodiments, the assembly component 404 is configured to organize only the retrieved portion of the collection. In one embodiment, the assembly component 404 is configured to organize the collection according to time, e.g., from first-to-last received, from latest-to-earliest, etc. For example, each item in the collection may have a timestamp associated therewith, and the assembly component 404 may sort the collection using the timestamp. In one embodiment, the assembly component 404 is configured to organize the collection according to communication type. For example, the assembly component 404 may sort the collection (e.g., the entirety or a subset) by communication type and/or file type.

The apparatus 400 includes a presentation component 406 configured to present, via an electronic display, at least a portion of the communication timeline to a user. In some embodiments, the presentation component 406 may be further configured to display an expandable version of each item in the timeline, such that a condensed version of the item is initially displayed and—when selected—the expandable item is extended to a full level of detail.

FIG. 5 depicts another embodiment of an apparatus 500 for collating communications of various types, according to embodiments of the disclosure. The apparatus 500 includes another embodiment of the timeline presentation apparatus 104 that includes a retrieval component 402, an assembly component 404, and a presentation component 406 that are substantially similar to those described above in relation to the apparatus 400 of FIG. 4. In various embodiments, the embodiment of the timeline presentation apparatus 104 additionally includes a trust indication component 508, a user interface component 510, and an attachment component 512, which are described below.

Note that the components 508-512 may include any component or set of components that perform the functionality attributed to the component. This may include one or more physical processors which execute processor-readable instructions, the processor-readable instructions (e.g., as software application or other executable), circuitry, computer hardware, storage media, some combination of software, hardware, and/or firmware, or any other components. The description of the functionality provided by the different components 508, 510, and/or 512 described below is for illustrative purposes, and is not intended to be limiting, as any of components 508, 510, and/or 512 may provide more or less functionality than is described. For example, one or more of components 508, 510, and/or 512 may be eliminated, and some or all of its functionality may be provided by other ones of components 508, 510, and/or 512. As another example, the apparatus 500 may comprise additional components that may perform some or all of the functionality attributed below to one or more of the components 508, 510, and/or 512.

The apparatus 500 includes a trust indication component 508 configured to identify one or more trust indicators associated with the collection and to present (e.g., in conjunction with the presentation component 406) one or more trust indicators to the user with the communication timeline (i.e., the trust indicator(s) corresponding the presented portion of the communication timeline). In one embodiment, the one or more trust indicators are generated through a sentiment analysis of the communications comprising the presented portion of the collection.

In certain embodiments, the trust indication component 508 uses one or more computer algorithms to flag messages within a collection where positive or negative identifiers may be meaningful (that can be further comprised of emotions like anger, anticipation, disgust, fear, joy, sadness, surprise, trust) that are derived from communications whether they are text based, audio or video.

For example, a business professional using this system in a transaction scenario may receive a communication from their client, where they are deemed to be upset (as determined by this system computer algorithm). This itemized message (as seen in the system application's timeline) may then have a warning icon placed by it, e.g., flame icon, and may include other pertinent data including a priority level, alerting the business professional of a possible issue with a contact(s) in relation to a transaction.

In some embodiments, the trust indication component 508 may send an alert to a system user (e.g., by email, text message or call back from the PBX IVR and/or a push notification issued through a supported application) when communications are flagged so that the system user may better prepare and/or take action without undue delay.

The apparatus 500 includes a user interface component 510 configured to receive, via a user interface, one or more comments from the user regarding a respective communication in the presented portion of the communication timeline. In certain embodiments, the user interface component 510 may store the one or more comments in the database 118. In one embodiment, the user interface component 510 may add metadata to the collection linking the one or more comments to the collection to which the respective communication belongs.

The apparatus 500 includes an attachment component 512 configured to identify a set of attachments, each attachment associated with a particular communication contained within the collection. Here, the attachment component 512, e.g., in conjunction with the presentation component 406, may present the set of attachments to the user, where the set of attachments comprises one or more of: a computer file, a document, an image, a video recording, an audio recording, or a combination thereof.

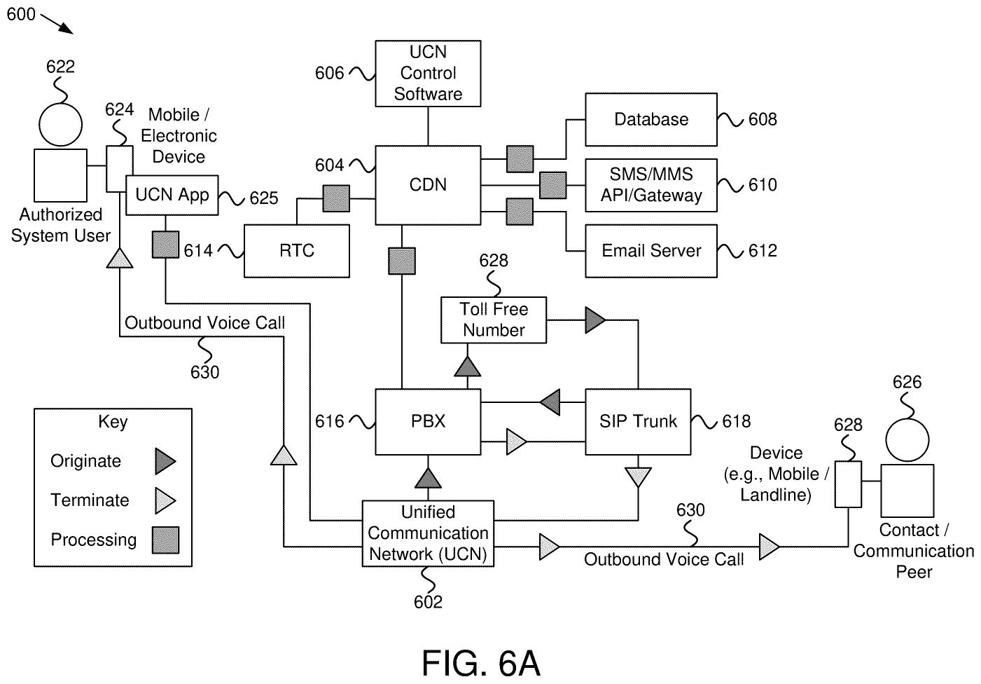

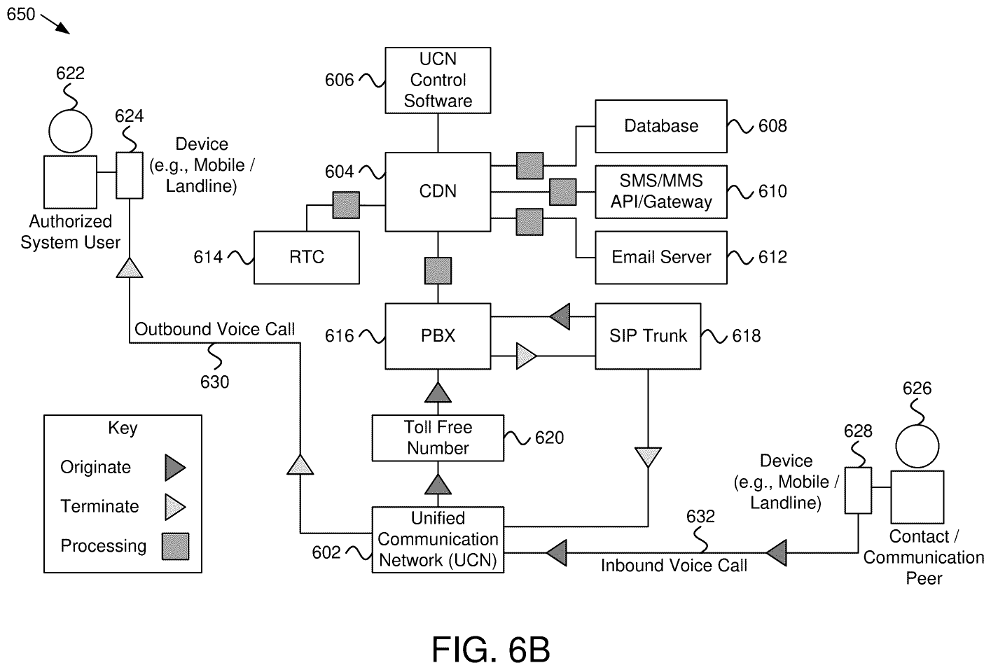

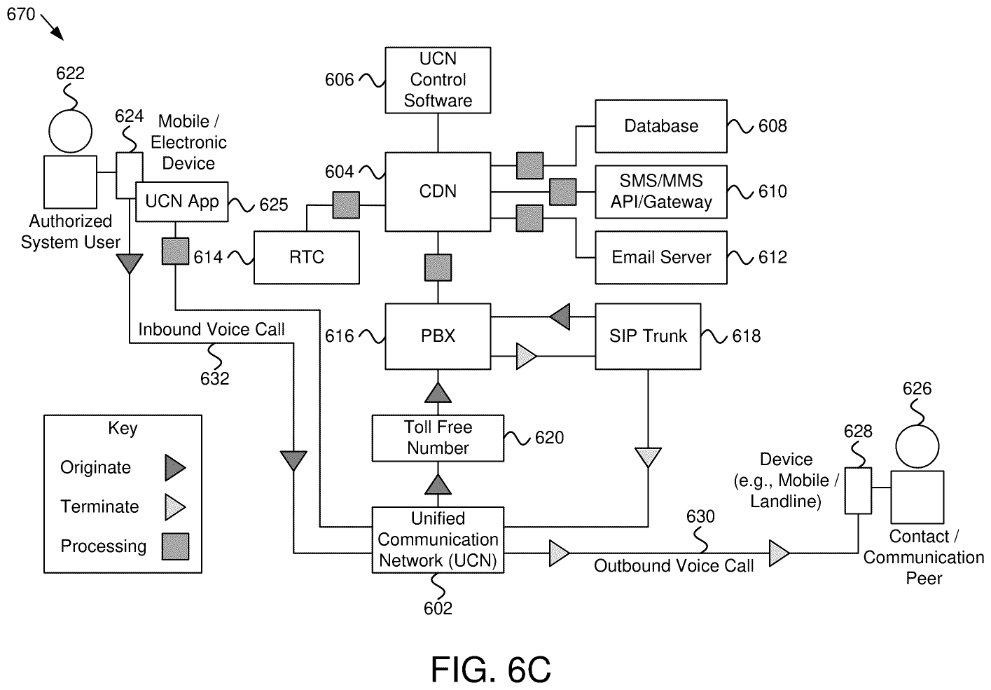

FIG. 6A depicts a system 600 that performs outbound call handling via a unified communication network (“UCN”) 602, according to embodiments of the invention. The system 600 may be one embodiment of the system 100 described above. The system 600 includes the UCN 602, a content distribution network (“CDN”) 604, UCN control software 606, a database 608 (e.g., an implementation of the database 118), a SMS and/or MMS Application Programming Interface (“API”) (or Gateway) 610 (denoted as “SMS/MMS API/Gateway”), an email server 612, an RTC server 614, a PBX 616 and SIP trunk 618 (i.e., a SIP server) associated with a toll-free number 620.

An authorized system user 622 may use the device 624 to place an outbound voice call 630 to a device 628 of a contact or communication peer 626 (denoted as “contact/communication peer”). In FIG. 6A-6C, the devices 624, 628 may be telephone devices, such as mobile phones and/or landline phones. In certain embodiments, the devices 624, 628 may be VoIP phones, software-based phones (“softphones”), of similar devices. In other embodiments, the device 624 may use a system application 625 (which may also be referred to as “UCN application”) to place the outbound voice call 630. Accordingly, the authorized system user 622 uses an application or an assigned phone number to reach the contact/communication peer 626.

When using the system application 625, the authorized system user 622 may select a collection and contact to call, in either order. If the authorized system user 622 first selects a contact, then the device 624 may display all collections linked to the contact, and the authorized system user 622 would then select a collection. In certain embodiments, the authorized system user 622 may then select the phone number they want to be called at. Note that the contacts, collections, and phone numbers are all information pre-stored in the system application 625. The user interface of the system application 625 makes this process fast to perform. The system application 625 connects to the PBX 616 via the UCN 602, e.g., using the toll-free number 620.

When the authorized system user 622 uses the system application 625 to initiate the call, in certain embodiments, the PBX 616 itself (e.g., the PBX auto-dialer) is considered the inbound caller/originator. The PBX 616 then establishes (via the SIP trunk 618 and UCN 602) two outbound voice call legs 630: one towards the authorized system user 622 and another towards the contact/communication peer 626. In some embodiments, the UCN 602 first calls the authorized system user 622 (as the initiating party). From the network perspective, the authorized system user 622 receives an outbound/terminated call; therefore, in some embodiments the device 624 may ring and, optionally, display a phone number/caller ID. In certain embodiments, the authorized system user 622 may also be billed for an outbound call. After the authorized system user 622 connects, the UCN 602 again acts as the originator and performs another outbound call towards the contact/communication peer 626.

In various embodiments, all call legs are merged through the SIP trunk 618. Note, however, that employing the SIP trunk 618 to merge call legs (e.g., to facilitate recording the voice call) may increase call charging, as described in greater detail below.

In one embodiment, the PBX 616 performs a callback first to the authorized system user 622 (i.e., at the selected phone number), and when the authorized system user 622 accepts the call, then the PBX 616 dials the device 628 of the contact/communication peer 626. In another embodiment, the PBX 616 dials the device 628 of the contact/communication peer 626, and when the contact/communication peer 626 accepts the call, then the PBX 616 performs a callback first to the device 624 of the authorized system user 622 (i.e., at the selected phone number). The collection and contact information is passed to the PBX 616 and when the communication is logged to the database 608 the collection is known, including all other call parameters. This may also include the call recording if permissions were granted, a text transcription of the call, and other related data.

When the authorized system user 622 calls directly using their assigned number (e.g., a DID number) and without using the system application, the PBX 616 may use an IVR to prompt the authorized system user 622 to select (e.g., by voice or keypad) the collection and contact (i.e., phone number of the contact/communication peer 626). Having received this information, the PBX 616 may then connect the call from the device 624 to the selected contact/phone number. Again, the PBX 616 has the collection and contact information it needs, and it knows the authorized system user 622 (e.g., from caller identification (“caller ID”) and/or by matching the assigned/DID phone number).

In certain embodiments, prior to connecting the call to the contact/communication peer 626, the PBX 616 may be configured to authenticate the authorized system user 622, e.g., by asking a security question or verifying a Personal Identification Number (“PIN”), or similar authentication information. When using the system application, the authorized system user 622 is identified by login credentials and will also have a valid session identification.

If recording preferences are known and recording authorization is granted, then the outbound voice call 630 will be recorded, and based on system configuration, the authorized system user 622 may receive a copy of the call when it is completed. For example, the UCN 602 may send an email to the authorized system user 622 that contains an audio file (i.e., comprising the recording of the outbound voice call 630) and may also include a text transcription of the outbound voice call 630, where the subject would identify the collection.

Note that the call handling shown in FIG. 6A logs the collection and contact information, etc., and creates an outbound call to all parties that originates from the PBX. However, when using toll-free numbers, this cost can become significant with increased scale. For example, in FIG. 6A the system operator (i.e., the operator of the UCN 602 with whom the authorized system user 622 has an account) pays for one inbound call (e.g., from the PBX 616) and two outbound calls (i.e., for each outbound leg of the outbound voice call 630). Typically, when employing a toll-free number, an inbound call is significantly cheaper than an outbound call. Therefore, the call handling shown in FIG. 6A may increase call charging, as compared to other solutions.

FIG. 6B depicts a system 650 that performs inbound call handling via a unified communication network (“UCN”) 602, according to embodiments of the invention. The system 650 includes the UCN 602, the CDN 604, the UCN control software 606, the database 608, the SMS/MMS API/Gateway 610, the email server 612, the RTC server 614, the PBX 616 and the SIP trunk 618 associated with the toll-free number 620. These entities are substantially similar to those described above in relation to FIG. 6A.

The contact/communication peer 626 may use the device 628 to place an inbound voice call 632 to the device 624 of the authorized system user 622. Here it is assumed that the contact/communication peer 626 is not an authorized user of the system 600, i.e., does not have an account, subscription, etc. with the system 600, but is known to the authorized system user 622. In some embodiments, the authorized system user 622 is associated with a business, and the contact/communication peer 626 is an individual client/consumer. In such embodiments, the contact/communication peer 626 may be categorized as a Business-to-Consumer (“B2C”) contact type. For example, in a real estate transaction, the authorized system user 622 may identify the contact/communication peer 626 as B2C. In some embodiments, the authorized system user 622 is associated with a business, and the contact/communication peer 626 is associated with another business, e.g., a supplier, contractor, etc. In such embodiments, the contact/communication peer 626 may be categorized as a Business-to-Business (“B2B”) contact type. In other embodiments, the relation between the authorized system user 622 is a business and the contact/communication peer 626 is uncategorized.

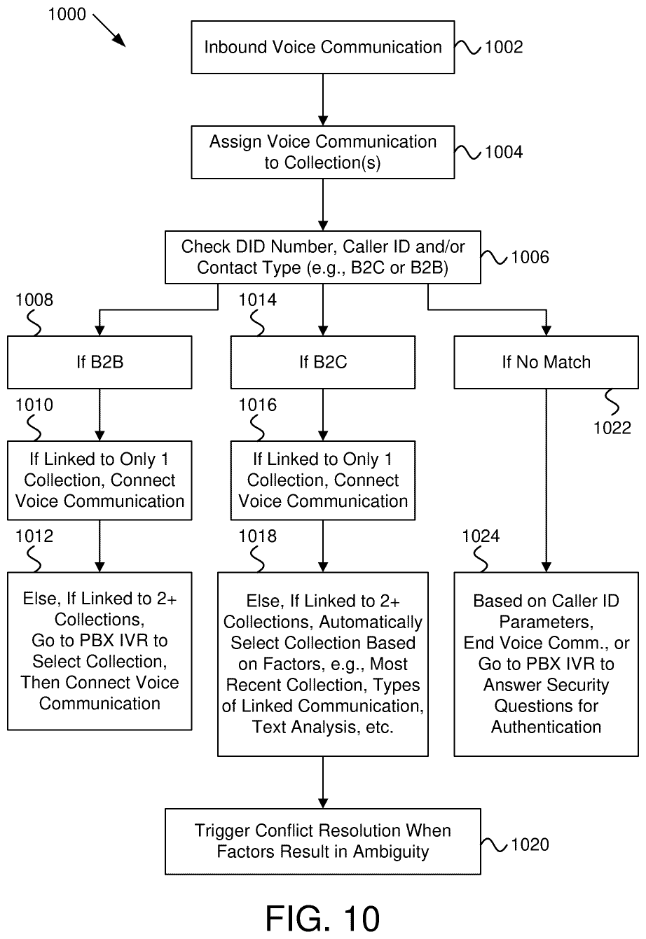

When the contact/communication peer 626 calls into the assigned phone number assigned to the authorized system user 622, the contact's information is located in the database, e.g., by using the caller ID of the contact/communication peer 626 and the phone number (e.g., DID number) assigned to the authorized system user 622. In most instances, the contact/communication peer 626 is only linked to one active collection, which is generally assigned by the authorized system user 622. In such embodiments, the inbound voice call 632 will be connected directly to the authorized system user 622, and the UCN 602 will find the best collection that matches the communication with the contact/communication peer 626. Schema for assigning/linking a voice call to a collection is described in greater detail below, with reference to FIG. 10.

While an inbound call from the user experience, from a network perspective, after the contact/communication peer 626 makes an inbound voice call 632 to the DID number of the authorized system user 622 (initiating the call as the originator), the call is routed to the PBX 616 and the call is then processed through the SIP trunk 618 and terminated to the device 624 of the authorized system user 622. Here, the PBX 616 may establish (via the SIP trunk 618 and UCN 602) an outbound voice call 630 towards the authorized system user 622. From the billing perspective, the system operator (i.e., the operator of the UCN 602 with whom the authorized system user 622 has an account) pays for one inbound call (e.g., the inbound voice call leg 632 from contact/communication peer 626 to the PBX 616) and one outbound call (i.e., the outbound voice call leg 630 from the PBX 616 to the authorized system user 622).

In one embodiment, if the contact/communication peer 626 calls in to an assigned phone number that is linked to multiple collections, then the PBX 616 may use an IVR to prompt the contact/communication peer 626 to select (e.g., by voice or keypad) the collection. Having received this information, the PBX 616 may then connect the call from the device 628 to the authorized system user 622. For example, the authorized system user 622 engaged in a building project has identified the calling contact/communication peer 626 as B2B in their contact profile; however, different collections may correspond to different aspects or phases of the building project. Accordingly, the calling contact/communication peer 626 may use the PBX IVR to identify the correct collection (and optionally contact) to connect too.

In some embodiments, the IVR directory would only contain contacts and collections to which the authorized system user 622 has linked the contact/communication peer 626. However, where the contact/communication peer 626 is also an authorized user, they would have the same experience as the authorized system user 622 in FIG. 6A. For example, if both users are using the system application (as authorized users) and all parties are actively logged into the system with the application, then when one authorized user calls another calling, the call may be connected and recorded using VoIP-to-VoIP.

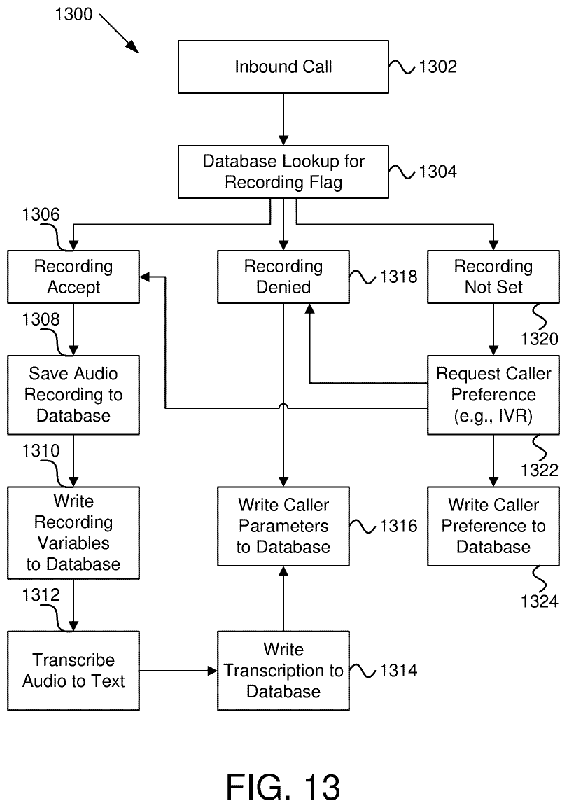

In certain embodiments, all authorized users agree in advance when using the system application calls may be recorded so no prompt or recording alert is needed. Note that authorized users may belong to different teams, divisions, departments, companies, organizations, etc. The handling of call recording is discussed in greater detail below, with reference to FIG. 13.

If recording preferences are known and recording authorization is granted, then the inbound voice call 632 will be recorded, and based on system configuration, the authorized system user 622 may receive a copy of the inbound voice call 632 when it is completed. For example, the

UCN 602 may send an email to the authorized system user 622 that contains an audio file (i.e., comprising the recording of the inbound voice call 632) and may also include a text transcription of the inbound voice call 632, where the subject would identify the collection.

FIG. 6C depicts a system 670 that performs outbound call handling via a unified communication network (“UCN”) 602, according to embodiments of the invention. The system 670 represents an alternative arrangement for outbound call handling with lower costs compared to the system 600. The system 670 includes the UCN 602, the CDN 604, the UCN control software 606, the database 608, the SMS/MMS API/Gateway 610, the email server 612, the RTC server 614, the PBX 616 and the SIP trunk 618 associated with the toll-free number 620. These entities are substantially similar to those described above in relation to FIG. 6A.

While the system 670 performs similar functions to the system 600 (described above with reference to FIG. 6A), several key differences exist. In the system 670, the authorized system user 622 uses the system application 625 to select the collection and contact(s) number to call. This communication-related information is now known as it is logged into the database 608.

However, instead of the authorized system user 622 selecting their phone number to initiate a PBX call-back to all parties (as in FIG. 6A), the authorized system user 622 triggers an inbound voice call leg 632 towards the UCN. In some embodiments, the system application 625 includes graphic or text hyperlink containing the appropriate DID number of the authorized system user 622. In one example, the authorized system user 622 may click/select a text hyperlink (e.g., <a href=“tel:18885551212”>Call Contact</a>) to trigger the inbound voice call leg 632. In another example, the authorized system user 622 may click/select a graphic hyperlink (e.g., <a href=“tel:18885551212”><img src=“make_call_icon.png”></a>).

This HTML code triggers the device 624 (i.e., enabled to make voice calls) to open a default application for the task (i.e. on a mobile phone this would be the native calling application) with the phone number preloaded from the hyperlink. In certain embodiments, the authorized system user 622 must then click/select the appropriate call icon of the this native (or default) application, e.g., as the user typically does to initiate a phone call.

While an outbound call from the user experience, because the system authorized user 622 is initiating/originating the call, it is treated as an inbound voice call leg 632 that will now be connected to the selected contact/communication peer 626. Moreover, the call can be logged, based on the last most recent entry entered in the database 608, that matches the calls characteristics to the entry, e.g., at the call's end. So, in the event the call is not made and perhaps one or more database entries were created that were never connected to an actual call (i.e., the authorized system user 622 got sidetracked or changed their mind), the UCN control software 606 may then match the most recent entry that aligns with the calls characteristics. Naturally, there can be other simultaneous calls occurring that would still get entered/logged correctly that may occur from different or the same methods based on different embodiment options, as their call characteristics would be different, and the UCN control software 606 may be applied based on the above embodiment used as well.

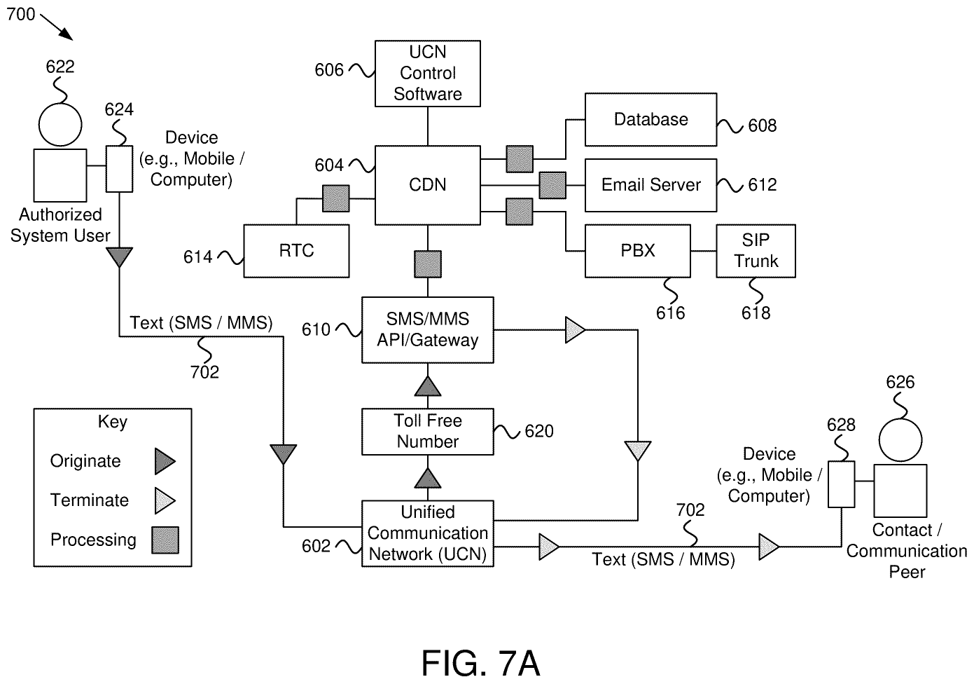

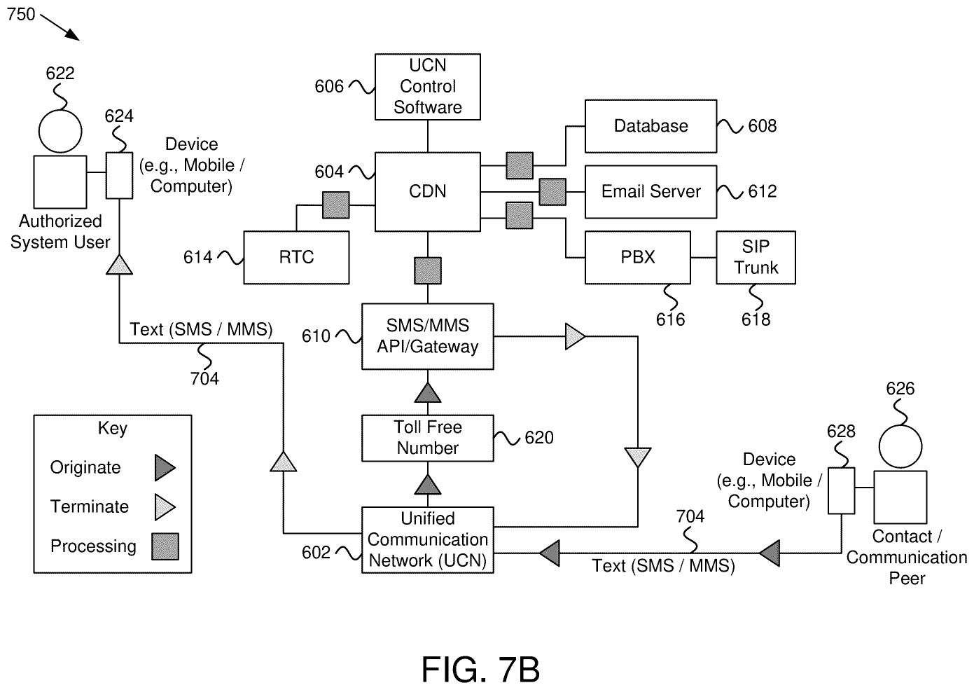

FIG. 7A depicts a system 700 that performs outbound text message 702 handling via a UCN 602, according to embodiments of the invention. Here, the text message may be an SMS message, an MMS message, or other text message. The system 700 includes the UCN 602, the CDN 604, the UCN control software 606, the database 608, the SMS/MMS API/Gateway 610 associated with the toll-free number 620, the email server 612, the RTC server 614, the PBX 616 and the SIP trunk 618. These entities are substantially similar to those described above in relation to FIG. 6A.

An authorized system user 622 may use the device 624 to send an outbound text message 702 to the device 628 of the contact/communication peer 626. In FIGS. 7A-7B, the devices 624, 628 may be electronic devices capable of sending and receiving text messages, such as mobile phones, smartphones, tablet computers, laptop computers, personal computers, other computing devices capable of sending and receiving text messages. In certain embodiments, the device 624 may use a system application to send the outbound text message 702. In various embodiments, the outbound text message 702 may be an SMS message, an MMS message, or the like.

If the authorized system user 622 is sending the outbound text message 702 with the system application, then the collection and the contact(s) (or contact group(s)) associated with the outbound text message 702 is known. Accordingly, the UCN control software 606—which collects the outbound text message 702 from the SMS/MMS API/Gateway 610—then saves this outbound text message 702 to the database 608, including the collection and the appropriate contact information. The UCN control software 606 may append collection information to the inbound text message 704 as needed (e.g., collection identifier, project name, routing code, etc.), and then the outbound text message 702 is relayed to the intended recipient(s) (i.e., including the contact/communication peer 626) back through the SMS/MMS API/Gateway 610.

In some embodiments, the SMS/MMS API/Gateway 610 is a third party processor that provides the gateway and allows the usage of various programming options to be performed in conjunction with their service. In certain embodiments, when using the SMS/MMS API/Gateway 610 all programming functionality is performed by the UCN alone. Both methods are likely to be employed for different scenarios.

While the above descriptions refer to an API, in other embodiments the SMS/MMS API/Gateway 610 may use a Software Development Kit (“SDK”), i.e., a software tool to facilitate the development of an application. In one embodiment, the SDK can take the form of an API. In the depicted scenarios, the SDK or API is used to handle text messaging. In one embodiment, the third party service/processor is a Tier 1 aggregator with access to the various popular mobile gateways (such as Verizon, AT&T, T-Mobile, Airtel, Jio, China Mobile, China Telecom, Telefonica, Vodafone, Orange, NTT Docomo, etc.). For text message handling, these Tier 1 service providers, or Tier 2 service providers that interface with Tier 1 providers may provide some custom programming that interfaces with the carriers, who in some instances may also offer an API, with likely at least some basic functionality. As used herein, a Tier 1 provider (also referred to as a Tier 1 “aggregator”) refers to a service provider that connects directly to the mobile gateway network of the telecom carrier(s). In contrast, a Tier 2 provider (also referred to as a Tier 2 “aggregator”) refers to a service provider that connects to the mobile gateway network of the telecom carrier(s) via a Tier 1 provider.

When not using a third party service/processor and their API or SDK, the SMS/MMS API/Gateway 610 may be a function of the UCN control software 606 that performs the text message handling (e.g., using custom programming/rules), in conjunction with a gateway used for routing (i.e., sending and receiving) messages via IP and to handle security credentials between service providers and carriers. In certain embodiments, the UCN 602 and/or UCN control software 606 act as a Tier 1 aggregator with access to the various popular mobile gateways. In other embodiments, the UCN 602 and/or UCN control software 606 may act as a Tier 2 provider.

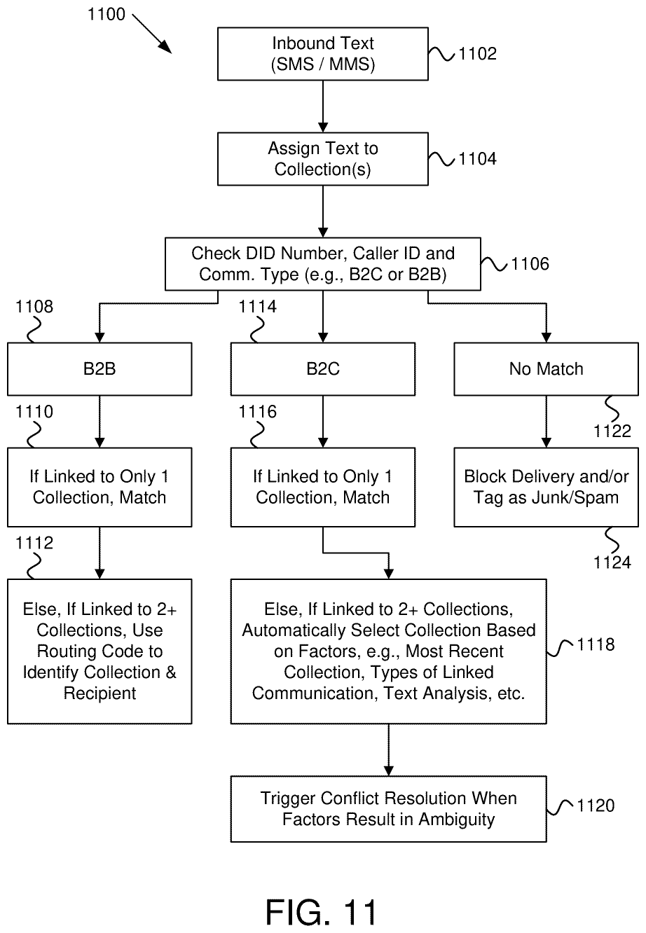

In certain embodiments, the authorized system user 622 sends the outbound text message 702 outside of (i.e., without using) the system application. In such embodiments, the authorized system user 622 may use any text messaging application, and a routing code may be used to more easily associate the outbound text message 702 with a particular collection, as described in greater detail below with reference to FIG. 11.

FIG. 7B depicts a system 750 that performs inbound text message 704 handling via a UCN 602, according to embodiments of the invention. Here, the text message may be an SMS message, an MMS message, or other text message. The system 750 includes the UCN 602, the CDN 604, the UCN control software 606, the database 608, the SMS/MMS API/Gateway 610 associated with the toll-free number 620, the email server 612, the RTC server 614, the PBX 616 and the SIP trunk 618. These entities are substantially similar to those described above in relation to FIG. 6A.

A contact/communication peer 626 may use the device 628 to send an inbound text message 704 to the device 624 of an authorized system user 622. In certain embodiments, the device 624 may use a system application to send the inbound text message 704. In various embodiments, the inbound text message 704 may be an SMS message, an MMS message, or the like.

Depending on system configuration and their assigned contact type—and possibly if the inbound text message 704 has been segregated by DID number, the contact/communication peer 626 may not need a routing code for any of their communications with authorized system users 622. In certain embodiments, other contact types (e.g., linked to multiple collections) would need a routing code or use the system application.

If the authorized system user 622 is receiving the inbound text message 704 with the system application, then the collection and the contact(s) (or contact group(s)) associated with the inbound text message 704 is known. Accordingly, the UCN control software 606—which collects the inbound text message 704 from the SMS/MMS API/Gateway 610—then saves this inbound text message 704 to the database 608, including the collection and the appropriate contact information. The UCN control software 606 may append collection information to the inbound text message 704 as needed (e.g., collection identifier, project name, routing code, etc.), and then the inbound text message 704 is relayed to the intended recipient(s) (i.e., including the authorized system user 622) back through the SMS/MMS API/Gateway 610.

In certain embodiments, the authorized system user 622 sends the inbound text message 704 outside of (i.e., without using) the system application. In such embodiments, the authorized system user 622 may use any text messaging application, and a routing code may be used to more easily associate the inbound text message 704 with a particular collection. Schema for assigning/linking a text message to a collection is described in greater detail below, with reference to FIG. 11.

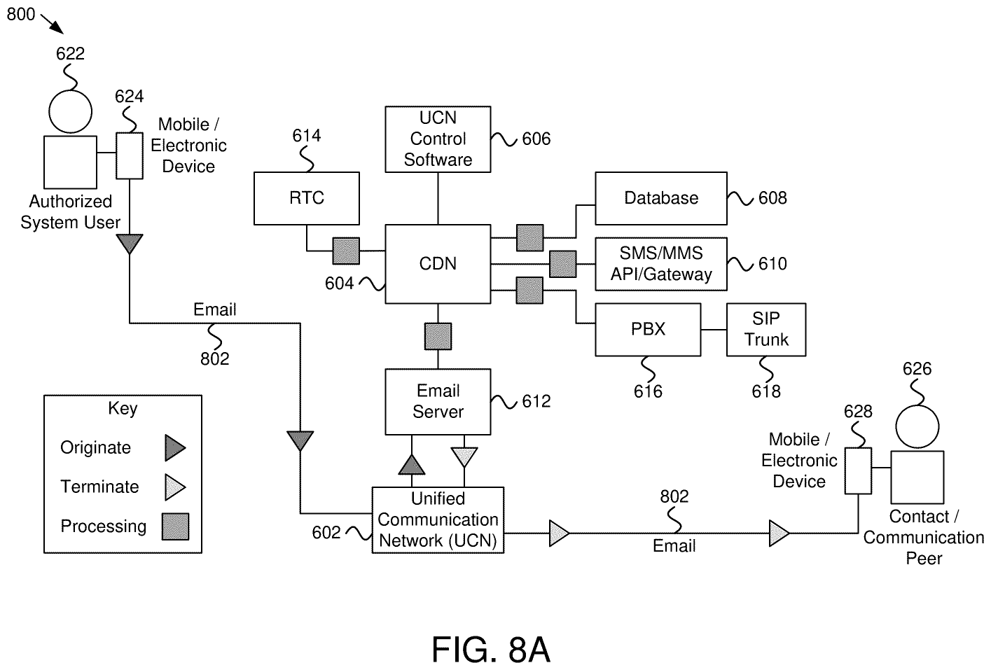

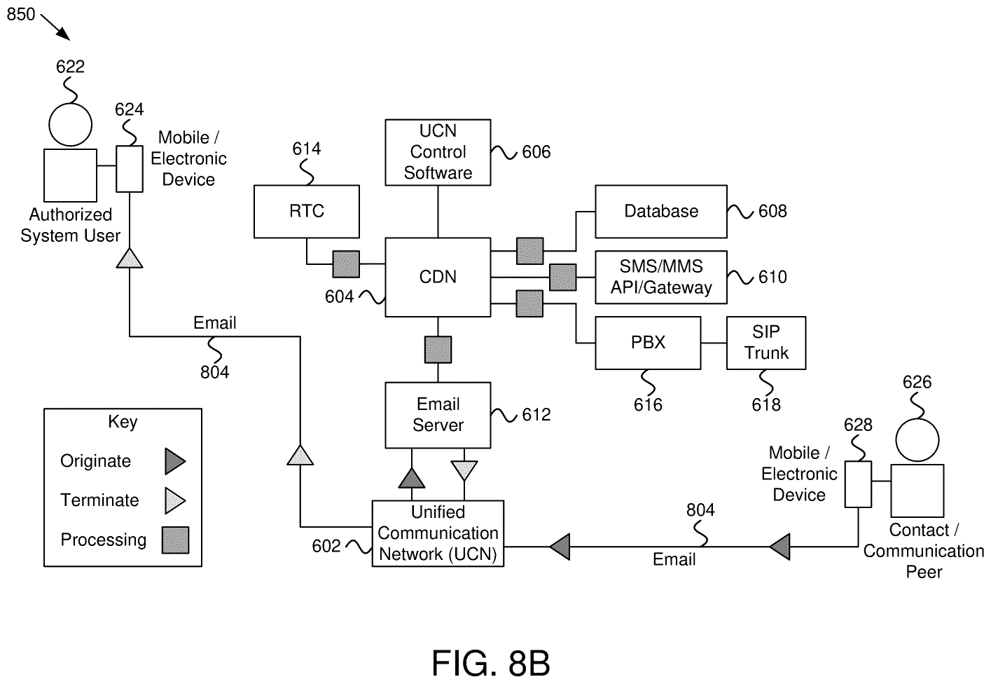

FIG. 8A depicts a system 800 that performs outbound email 802 handling via a UCN 602, according to embodiments of the invention. The system 800 includes the UCN 602, the CDN 604, the UCN control software 606, the database 608, the SMS/MMS API/Gateway 610, the email server 612, the RTC server 614, the PBX 616 and the SIP trunk 618. These entities are substantially similar to those described above in relation to FIG. 6A. An authorized system user 622 may use the device 624 to send an outbound email 802 to the device 628 of the contact/communication peer 626, as described in greater detail below.

FIG. 8B depicts a system 850 that performs inbound email 804 handling via a UCN 602, according to embodiments of the invention. The system 850 includes the UCN 602, the CDN 604, the UCN control software 606, the database 608, the SMS/MMS API/Gateway 610, the email server 612, the RTC server 614, the PBX 616 and the SIP trunk 618. These entities are substantially similar to those described above in relation to FIG. 6A. A contact/communication peer 626 may use the device 628 to send an inbound email 804 to the device 624 of the authorized system user 622.

In FIGS. 8A-8B, the devices 624, 628 may be electronic devices capable of sending and receiving emails, such as mobile phones, smartphones, tablet computers, laptop computers, personal computers, other computing devices capable of sending and receiving emails. In various embodiments, emails may be sent or received using any application (e.g., email client or web client) of choice.

In various embodiments, the system 800 assigns an email address associated with a particular collection. This email address may be used by the authorized system user 622 and their contacts (e.g., contact/communication peer 626) when the desired goal is to collate emails into a collection with all other associated communications. In certain embodiments, a particular email address of an authorized system user 622 is associated with one collection. In other embodiments, a particular email address of an authorized system user 622 is associated with multiple collections.

In cases where the authorized system user 622 uses a non-system-assigned email address, for example to send copies (e.g., blind carbon copy (“BCC”) or carbon copy (“CC”)) from a third-party electronic document service, an identifier may be added to the email subject line so that these emails and their attachments can be collated into the correct collection. In one embodiment, for proper assignment, the authorized system user 622 ensures that the email subject line contains an acceptable like match to the collection name previously entered into this system. If a match cannot be made, the UCN 602 and/or UCN control software 606 may attempt to parse the email body or other header fields to identify one or more candidate collections. In certain embodiments, the UCN 602 may prompt for manual assignment by an authorized system user 622 when a match cannot be made from the subject line. For example, the UCN 602 may issue an email or text message for clarification by hyperlink or reply back text.

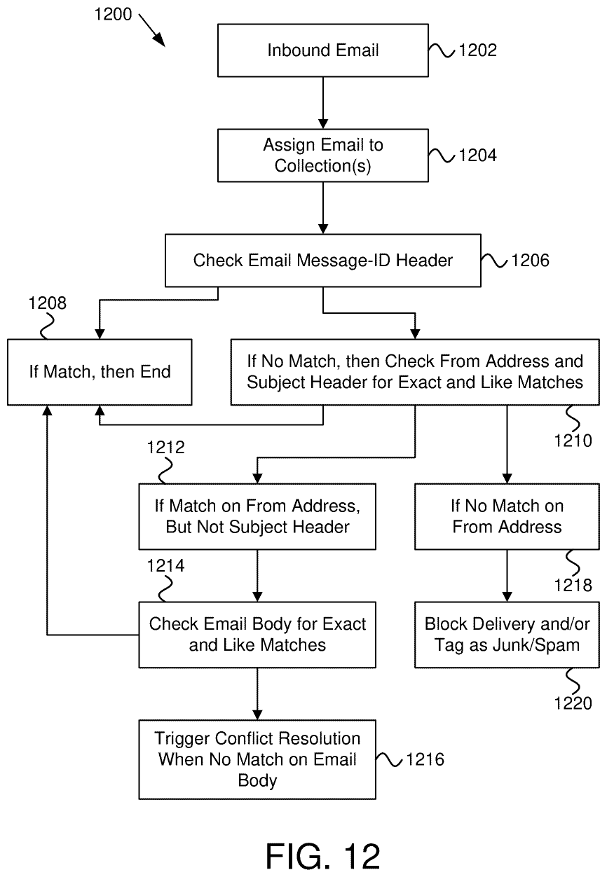

As authorized system users 622 and contacts/communication peers 626 reply back to their emails (e.g., in an email chain or conversation), the UCN 602 is able to parse email header information and ensure the collection is properly assigned. However, if an email contains insufficient information to unambiguously identify a collection, the UCN 602 may analyze other email characteristics to match the email to the correct collection (or generate a new collection). Schema for assigning/linking an email to a collection is described in greater detail below, with reference to FIG. 12.

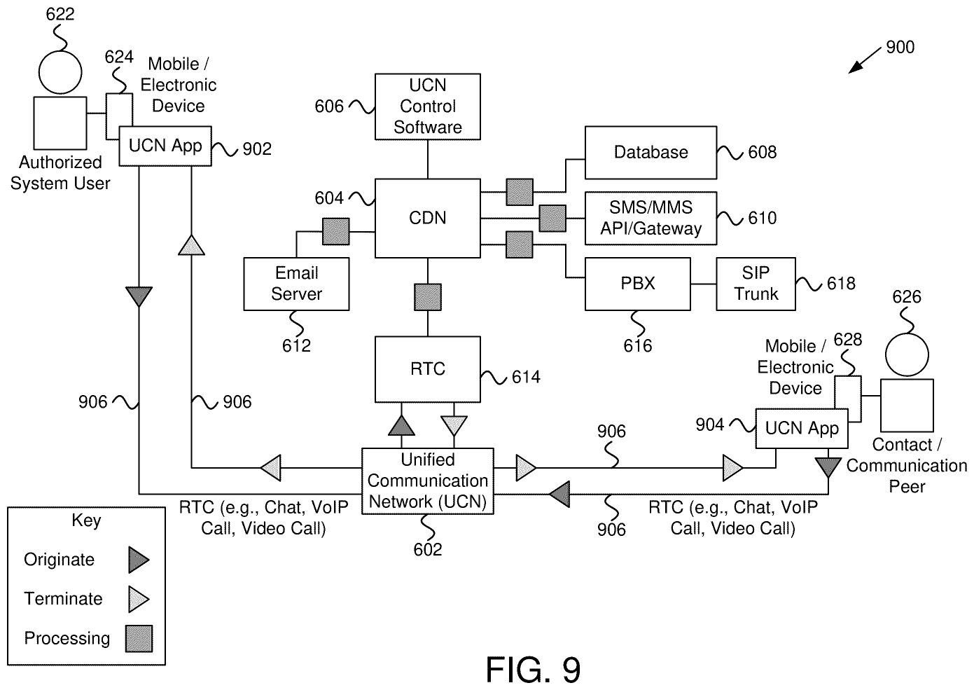

FIG. 9 depicts a system 900 that performs RTC handling via a UCN 602, according to embodiments of the invention. Here, the RTC 906 may be a Chat session, a VoIP call, a video call, or the like. The system 900 includes the UCN 602, the CDN 604, the UCN control software 606, the database 608, the SMS/MMS API/Gateway 610, the email server 612, the RTC server 614, the PBX 616 and the SIP trunk 618. These entities are substantially similar to those described above in relation to FIG. 6A.

An authorized system user 622 may use a UCN application 902 (e.g., an instance of the system application 625) running on the device 624 to initiate and/or respond to RTC with a UCN application 904 (e.g., another instance of the system application 625) running on the device 628 of the contact/communication peer 626. In FIG. 9, the devices 624, 628 may be electronic devices capable of sending and receiving RTC 906, such as mobile phones, smartphones, tablet computers, laptop computers, personal computers, other computing devices capable of sending and receiving text messages.

In certain embodiments, the UCN application 902 and UCN application 904 are different instances of the same system application configured for RTC 906. In other embodiments, the UCN application 902 associated with an authorized system user 622 have additional features as compared to the UCN application 904. When using the UCN applications 902, 904 to perform calls, texts and emails, after selecting a collection, there are a lot of connection and distribution options then typical with a normal application.

When the UCN applications 902, 904 are employed for peer-to-peer(s) communications, the RTC 906 can include chat (e.g., instant message) but still be capable of issuing SMS/MMS text messages for those not participating by UCN application. In certain embodiments, the UCN applications 902, 904 are employed for VoIP-to-VOIP and video calls.

The UCN 602 collates these RTC 906 to their appropriate collection as identified by manual selection in the application. In some embodiments, the RTC 906 are provided occur from a dedicated module. In other embodiments, the RTC 906 are provided by modules part of another component, like available as built-in functionality or an add-on from the PBX 616.

In certain embodiments, when using the UCN application 902, an authorized system user 622 could assign multiple collections to communications they are going to perform. In one embodiment, the UCN application 902 can have a folder for manual assignment of communications for which the UCN 602 did not ascertain a related collection with a threshold certainty. Additionally, via the UCN application 902, the authorized system user 622 may have the option to either reassign a communication to a different collection or to manually link the communication to more than one collection.

FIG. 10 depicts an exemplary schema 1000 for linking a voice communication to a particular collection, according to embodiments of the disclosure. The schema 1000 includes detecting, e.g., by the UCN 602 an inbound voice communication 1002 and determining, e.g., by the UCN control software 606, to assign 1004 the voice communication to one or more collections.

The schema 1000 includes checking a DID number, caller ID, and/or contact type (e.g., B2C or B2B) 1006. If the contact type is determined to be B2B 1008, and if the DID number and/or caller ID are linked to only one collection, then the UCN control software 606 connects the voice communication 1010. Otherwise, if the DID number and/or caller ID are linked to multiple collections, then the UCN control software 606 uses the PBX IVR to select a particular collection (e.g., one of the multiple linked collections) and connects the voice communication 1012.

If the contact type is determined to be B2C 1014, and if the DID number and/or caller ID are linked to only one collection, then the UCN control software 606 connects the voice communication 1016. Otherwise, if the DID number and/or caller ID are linked to multiple collections, then the UCN control software 606 automatically selects a collection based on factors, e.g., most recent collection, types of linked communication, text analysis, etc. 1018.

However, if the factors result in ambiguity (e.g., the UCN control software 606 did not ascertain a related collection with a threshold certainty), then the UCN control software 606 triggers a conflict resolution protocol, such as flagging the voice communication for manual assignment to a collection 1020.

If the contact does not match B2C or B2B 1022, then based at least on the caller ID parameters, the UCN control software 606 may end the voice communication, or use the PBX IVR to have the caller answer security questions for authentication 1024.

In various embodiments, the PBX IVR may perform error handling for voice calls from unrecognized caller IDs that may be authorized to use the system. For example, client “John Doc” may have a home, cell and work number saved to his contact profile by a system user, but makes a call in regards to a transaction from an unrecognized landline. A series of security questions allow authorization via the PBX IVR (and/or secondary authorization, like a code provided by text message that can be given for authorization to the PBX IVR by keypad).

In some embodiments, this PBX IVR functionality may also provide the ability to save an unrecognized number that the contact intends to use frequently for subsequent calls. In certain embodiments, the security questions might ask for the transaction name, an email address, a phone number and a zip code on file to verify the caller.

In some embodiments, some callers may experience an immediate end to their call before the above option, based on their caller ID. For example, the number is listed as a SPAM number or other factors can contribute to this like the geo-location of other communications that arrived recently, make it impossible for the caller to now be in the current geo-location the call is originating from.

FIG. 11 depicts an exemplary schema 1100 for linking a text communication to a particular collection, according to embodiments of the disclosure. The schema 1100 includes detecting, e.g., by the UCN 602 an inbound text communication (e.g., SMS, MMS) 1102 and determining, e.g., by the UCN control software 606, to assign 1104 the text communication to one or more collections.

The schema 1100 includes checking a DID number, caller ID, and/or contact type (e.g., B2C or B2B) 1106. If the contact type is determined to be B2B 1108, and if the DID number and/or caller ID are linked to only one collection, then the UCN control software 606 assigns the text communication to the matching collection 1110. Otherwise, if the DID number and/or caller ID are linked to multiple collections, then the UCN control software 606 uses a routing code to identify a particular collection (e.g., one of the multiple linked collections) and recipient 1112.

If the contact type is determined to be B2C 1114, and if the DID number and/or caller ID are linked to only one collection, then the UCN control software 606 assigns the text communication to the matching collection 1116. Otherwise, if the DID number and/or caller ID are linked to multiple collections, then the UCN control software 606 automatically selects a collection based on factors, e.g., most recent collection, types of linked communication, text analysis, etc. 1118.

However, if the factors result in ambiguity (e.g., the UCN control software 606 did not ascertain a related collection with a threshold certainty), then the UCN control software 606 triggers a conflict resolution protocol, such as flagging the text communication for manual assignment to a collection 1120. Note that based on the accumulated data, the system may link this collection to the most current collection, link it to more than one current collection, or place it in a queue for manual assignment. Additionally, the UCN 602 may issue a text or email alert with a link or reply code to an authorized system user 622 to link/assign the text communication as it pertains to one or more collections on file.

If the contact does not match B2C or B2B 1122, then based at least on the caller ID parameters, the UCN control software 606 may block delivery of the text communication and/or tag the text communication as junk or SPAM 1124.

In certain embodiments, the UCN 602 and/or UCN control software 606 may block unwanted communications (e.g., junk or SPAM communications) by denying and blocking any communications that are not recognized as an authorized user's contact and optionally by checking if the contact is linked to an existing collection (e.g., from all the communication types it supports) both preemptively and automatically. This is possible because all inbound communications attempting to enter this system are cross checked against authorized contacts connected to a user's account, saved to the database.

In certain embodiments, an option may also exist to block these communications if they are not also actively linked to a collection structure. This methodology can be further fine-tuned, for example if a contact is linked to what is deemed as one or more active collections.

In certain embodiments, for voice calls and text messages, the assigned inbound DID number being used must match the contact's DID number assigned to them and one of their caller IDs (i.e., mobile, work, home, other(s)) on file in conjunction with the system user's DID number assigned for public distribution (as they also have a private DID number to reach the PBX).

In certain embodiments, for email, the FROM address must match a contact's profile associated with a system user, and the TO address must also match the assigned email address of the system user, and there must be an acceptable match in the subject or body that correlates to a collection like a transaction that the contact is linked to, or an exact match exists to a message-id header in the email's headers (i.e., used by this system to create a unique recognizable ID allowing a continuous email chain specific to a collection) or if a routing code has been added to the email's body, it must be an exact match.

In some embodiments, multiple combinations of data would be checked as applicable. Thus, with this methodology there is no post-delivery clean up required, like with an email junk folder, or the need to block an inbound caller number (either voice or text) on a mobile device after the call was already received, or the problem of wanted emails that end up in a junk folder or fussing with marking communications as junk/SPAM.

Moreover, the blocking of unwanted communications further limits the exposure of system users and their contacts to both dangerous and fraudulent communications associated with SPAM for example that could be masquerading as part of a transaction, for example, the passing of fraudulent bank wire instructions, or AI (artificial intelligence) voice impersonation. Additionally, system users attempting to SPAM or make unwanted communications to other system users or their contacts would not succeed, as they are subject to the same security rules that apply to the contacts of system users.

FIG. 12 depicts an exemplary schema 1200 for linking an email communication to a particular collection, according to embodiments of the disclosure. The schema 1200 includes detecting, e.g., by the UCN 602 an inbound email communication 1202 and determining, e.g., by the UCN control software 606, to assign 1204 the email communication to one or more collections.

The schema 1200 includes checking an email Message-ID header 1206. If the Message-ID header matches a defined collection, then the UCN control software 606 assigns the email communication to the matching collection 1208. Otherwise, if there is no match based on the email Message-ID header, then the UCN control software 606 checks the From address and the Subject header for an exact or like (i.e., partial) match 1210. If the From address and the Subject header are an exact match to a defined collection, then the UCN control software 606 assigns the email communication to the matching collection 1208.

Else, if the From address matches at least one defined collection, but there is no match based on the email Subject header 1212, then the UCN control software 606 checks the email body for exact or like matches 1214. If the email body has a match for a defined collection, then the UCN control software 606 assigns the email communication to the matching collection 1208.

Else, if there is no match based on the email body, then the UCN control software 606 triggers a conflict resolution protocol, such as flagging the email communication for manual assignment to a collection 1216. Note that based on the accumulated data, the system may link this collection to the most current collection, link it to more than one current collection, or place it in a queue for manual assignment. Additionally, the UCN 602 may issue a text or email alert with a link or reply code to an authorized system user 622 to link/assign the email communication as it pertains to one or more collections on file.

Otherwise, if there is no match based on the From Address 1218, then the UCN control software 606 may block delivery of the email communication and/or tag the email communication as junk or SPAM 1220.

FIG. 13 depicts an exemplary schema 1300 for handling recording preference, according to embodiments of the disclosure. The schema 1300 includes detecting, e.g., by the UCN 602 an inbound call 1302 (e.g., voice communication) and performing, e.g., by the UCN control software 606, a lookup in the database 608 to examine a recording flag 1304 associated with caller/contact and/or a collection associated with the caller/contact.

If the recording flag indicates that recording is accepted 1306, then the UCN control software 606 creates an audio recording and saves the audio recording 1308 to the database 608. Additionally, the UCN control software 606 writes recording variables 1310 to the database 608. In certain embodiments, the UCN control software 606 may transcribe the audio recording to text 1312 and write the transcription 1314 to the database 608. Further, the UCN control software 606 writes caller parameters 1318 to the database 608.

If the recording flag indicates that recording is denied 1316, then the UCN control software 606 only writes caller parameters 1318 to the database 608.

Else, if there is no recording flag set 1320 in the database 608, then the UCN control software 606 request caller preference 1322, e.g., using the PBX IVR. Note that in locations/jurisdictions where recording permission from the caller is not needed, the recording may be assumed to be allowed (i.e., preference is set to ‘recording accept’ by default).

The system 100 provides an authorized user with the inbound and outbound recording status for each contact they add, available prior to calling the contact. This inbound and outbound recording status may vary per contact. For example, John Doe's recording preferences may read, “Recording Inbound: Auto Enabled, Recording Outbound: Auto Enabled” whereas Jane Smith's might read “Recording Inbound: Auto Enabled, Recording Outbound: App” where the user selects an option.

Other useful more detailed notes may be added, for example, *Contact receives an inbound recording prompt enabling call recording. This does not cover outbound calls, so the application user may need to select a handling option.

In instances where a contact of an authorized user may not have selected their recording preferences yet, or the contact is only notified of the recording process for their inbound calls by recording prompt. Where a jurisdiction requires “two party consent”, an authorized user that is initiating the call to a contact may then be required, prior to initiating the call, to either allow for beep tones to be played during the call or a prompt stating that the call is being recorded, which may be used as an acceptable method of recording notification to then record the call, or to select to disable call recording. Presenting this information to the authorized user, in some embodiments, occurs by automation, while manual selection by the authorized user makes the final recording method determination, either by keypad, button, link or voice command.

The authorized user, in some embodiments, is also be notified and/or provided with additional recording options if the authorized user has changed geographic location and/or a contact, as determined by the system 100 monitoring the location of the authorized user. In other embodiments, recording notification options may be changed from authorized user manual input, which may be a more common method with contacts not using the system 100, and is also typically performed for all contacts if the contacts change their state of residence. For example, if the authorized user or a contact or both have travelled to a different state, changing the previous consent state status between the authorized user and contact may then require different recording protocols. Recording condition status, notifications, alerts and warnings may also be delivered by IVR prior to connecting the call.

Having received the caller preference (e.g., ‘recording accept’ or ‘recording deny’), the UCN control software 606 writes the caller preference 1324 to the database 608. Additionally, the UCN control software 606 follows the procedures for when recording is accepted (e.g., beginning at block 1306) or when recording is denied (e.g., beginning at block 1318), respectively.

In various embodiments, assuming recording permission was granted, the UCN control software 606 may deliver an email or text message to a B2C contact containing a copy of the call recording.

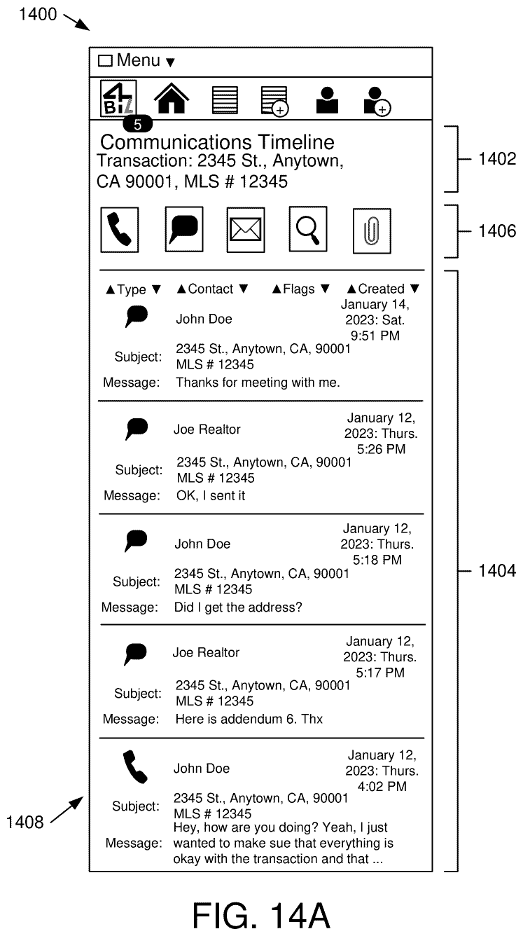

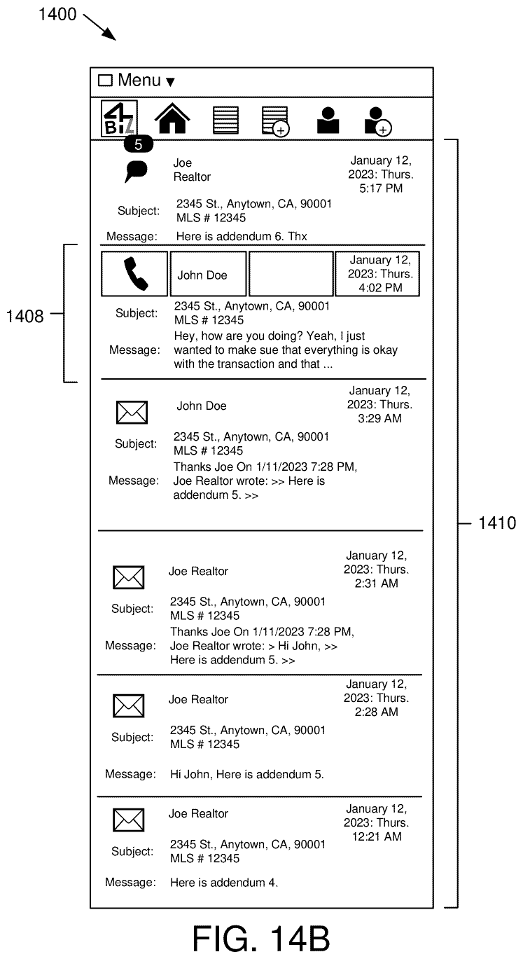

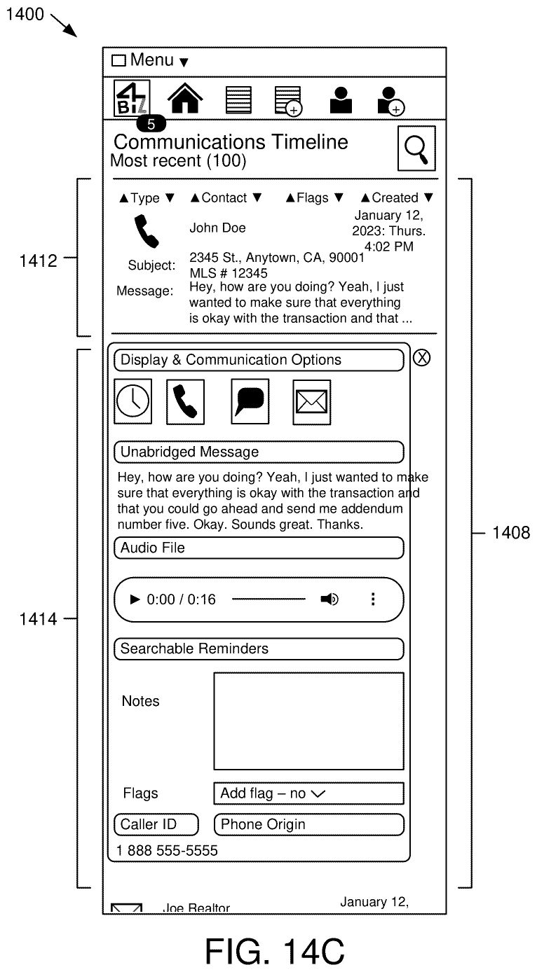

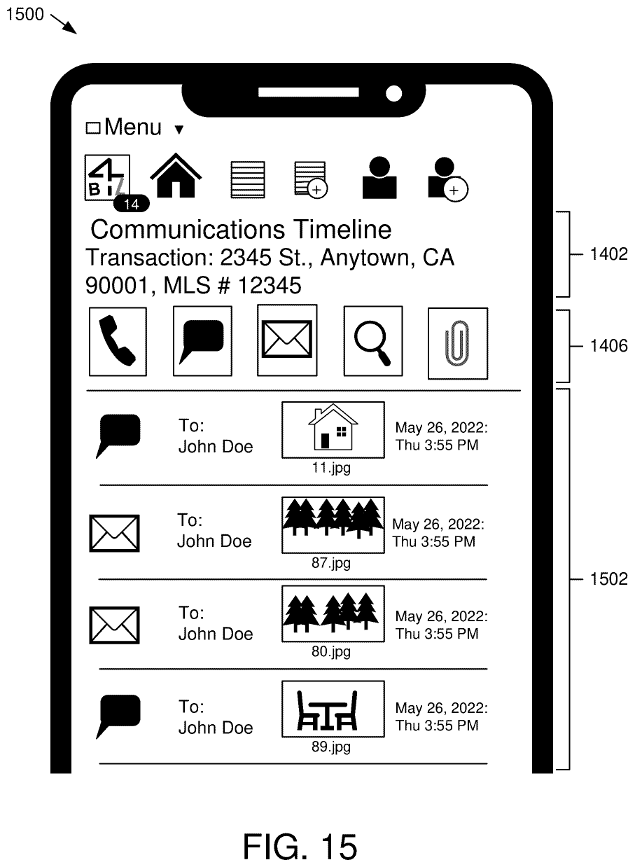

FIGS. 14A, 14B, 14C, and 15 depict aspects of the presentation of a communications timeline corresponding to a collection of communications, according to embodiments of the disclosure. In the depicted embodiment, the collection corresponds to a real estate transaction and is identified by a transaction name 1402—here, the address of a property and a listing number. As described herein, the communications timeline may display only a subset of the communication in the collection.

FIG. 14A depicts a first view of a user interface 1400 presenting the communications timeline, which comprises multiple items 1404 corresponding to communications in the collection. FIG. 14B depicts a second view of the user interface 1400, which presents additional items 1410 corresponding of the communications timeline.

In some embodiments, each item 1404 includes an indication (e.g., using an icon, text, etc.) of the communication type (e.g., text message, call/voice communication, email, etc.), an originator of the communication, and a timestamp of the communication. In certain embodiments, each item 1404 includes a subject field and a message field.

In the depicted embodiment, the subject field may identify the collection. In further embodiments, the subject field may include additional information of the collection, information of the individual communication, and/or information of the parties involved in the communication.

In the depicted embodiment, the message field may include up to a predetermined words or characters. In further embodiments, the message field may include a computer-generated summary of the communication, additional information of the collection, information of the individual communication, and/or information of the parties involved in the communication.

In certain embodiments, a user may use the controls 1406 to filter, sort, search, and/or re-order the multiple items 1404. For example, the user may filter the collection so that only a specific type of communication is presented in the communication timeline. As another example, the user may filter the collection so that only attachments or files associated with the collection are presented in the communication timeline.

The user may navigate the user interface to view different communications on the communication timeline. The user may further select a particular communication 1408 to view further information and/or contents of the selected communication 1408.

FIG. 14C depicts a third view of the user interface 1400 showing an expanded view of the selected communication 1408. In the depicted embodiment, the expanded view includes a synopsis 1412 of the selected communication 1408 and a detailed view 1414 of the selected communication 1408. In one example, the synopsis 1412 of the selected communication 1408 is what is depicted in the non-expanded view of the communication timeline, e.g., corresponding to FIGS. 14A-14B. In another example, the detailed view 1414 includes a set of display and communication options, an unabridged version of the selected communication 1408, an interface for adding notes/comments and/or flags regarding the selected communication 1408, caller ID, or the like.

In some embodiments, the set of display and communication options allows for follow-up to the selected communication 1408, e.g., to schedule a meeting or other follow-up action, to initiate a voice communication (e.g., call), to initiate a text message communication (e.g., SMS or MMS), to initiate an email communication, etc.

For a text-based communication, the unabridged version of the selected communication 1408 may comprise the entirety of the communication. For a video- or audio-based communication, the unabridged version of the selected communication 1408 may comprise a transcript of the audio and frame for playback of the audio (and/or video) corresponding to the selected communication 1408.

In some embodiments, the comments/notes regarding the selected communication 1408 may be searchable text, such as searchable reminders to be associated with the selected communication 1408. In some embodiments, the flags regarding the selected communication 1408 may include an indication whether follow up is needed, whether the communication was positive, whether the communication was negative, etc. In certain embodiments, the flags may indicate that comments and/or notes added to the communication. Here, the flags may be used to find comments/notes related to a transaction or project. For example, after a year someone might not remember what to search for in a collection to bring up communications with important comments, but use flags to find them, such as where a real estate agent made notes about a particular disclosure (e.g., an casement issue) that may have even been added to various communications she had with a client per a specific collection and/or transaction. These notes could be spread across various communication types and make sorting by flags a quick way to reach them. Additionally, a user may also search by comments.

In various embodiments, when using the system application, a system user can reply or forward any type of communication in the timeline. For example, in a native text message application it may not be possible to reply back to prior messages in the chain as typical of an email, rather the native text message application may only reply to the last chronological message in the linear chain.

In some embodiments, the system application allows the system user to reply back to any text message, whereby the new message would include the contents of the older message being replied back to like an email, where the subject could be appended with Re: and the reply contents are included in the message. Accordingly, when peer-to-peer communications are performed for a text message, the system application may allow the reply to be performed similar to real time chat or an instant message environment.

In certain embodiments, if one or more end users are receiving SMS or MMS text messages (e.g., not using this systems application), the communications can be sent by SMS or MMS to the recipient (contact or contact group) linked to the collection.

In certain embodiments, a phone call or voicemail that is saved with a text transcription and audio file can also be replied to or forwarded, including video calls, that may also contain the audio converted to a text transcription. Additionally, combinations of communications can be selected for replying back to or forwarding.

For example, a user replies back to a text message and phone call both combined in one communication. Furthermore, when replying back or forwarding (or sharing) the application user can select one or more methods of message transmission. Thus, if the messages (communications) being replied back to (containing a phone call and text message) could be sent by email or text message, or it might be sent to both simultaneously at the user's discretion.

In some embodiments, this reply functionality applies equally to forwarding, where any text message, phone call, video call, email, chat or related can be selected individually or grouped in any combinations to be forwarded, including one or more transmission (sending) options can be selected. However, in certain embodiments this reply functionality may have a limit applied that might be based on number of communications, data allocated for delivery, and this may be further limited by the delivery protocols selected.

FIG. 15 depicts an exemplary user interface 1500 presenting a communications timeline, which comprises multiple items 1502 corresponding to attachments associated with the communications in the collection. Note that the user interface 1500 presents the transaction name 1402 and one or more controls 1406.

In certain embodiments, the items 1502 are presented in response to a user using the controls 1406 to filter the collection so that only attachments or files associated with the collection are presented in the communication timeline.

In some embodiments, each item 1502 includes an indication (e.g., using an icon, text, etc.) of a communication type to which the attachment was attached, an originator of the communication, a preview of the attachment, and a timestamp of the communication.

In various embodiments, a system user and those they have authorized can display all accumulated attachments specific to a collection (e.g., regardless of communication type, like images, photos, audio, video, files, documents and related) and retrieve all from one location in a timeline. These accumulated attachments may be sorted, downloaded individually, or compressed (containing one or more attachments), replied back to or forwarded and shared as needed. The attachment lists may also include the audio files from phone calls and the video file from video calls.

In certain embodiments, to save space, a download hyperlink could be included in a message, where this link could open a web page that displays them. The use of downlink hyperlinks is also useful for communications like text messages or emails that may have attachment limitations.

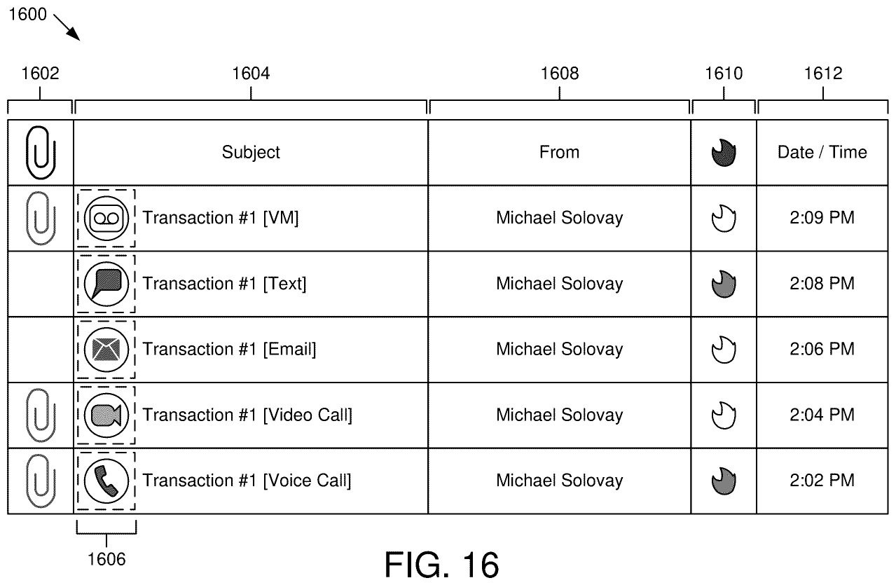

FIG. 16 depicts an exemplary presentation 1600 of an email archive corresponding to a collection of communications, according to embodiments of the disclosure. One column 1602 of the presentation 1600 indicates whether a respective communication includes an attachment. In some embodiments, the corresponding email may include a recording/capture of the original communication, for example, when the original communication is a voice call, video call, voicemail, etc.

In some embodiments, voicemail that originates from this system and the contact the generated it can be collated as well into the communication timeline as it pertains to its associated collection. In certain embodiments, voicemail (“VM”) communications are uniquely identified in the timeline by icon and text and also contain the audio playback file, text transcription and all other details included in all other communication types and functionality.

One column 1604 of the presentation 1600 indicates a subject of the email. In the depicted embodiment, an icon 1606 may be inserted into the email subject field to visually indicate the communication type of the original communication. In certain embodiments, a text indication of the communication type of the original communication may be inserted into the email subject field (e.g., at an end of the subject field). The subject field may additionally indicate the collection name (depicted here as “Transaction #1”).

One column 1608 of the presentation 1600 indicates an originator of the original communication. Note that the originator of the original communication may be different than the sender of the actual email received at the archive.

One column 1610 of the presentation 1600 indicates an emotion identifier, e.g., representing a positive or negative emotion associated with the original communication. In certain embodiments, the emotion identifier is determined based on a sentiment analysis of the communication, e.g., using a natural language analysis of the content and context of the communication.

One column 1612 of the presentation display a timestamp associated with the original communication. Note that the timestamp associated with the original communication may be different than a timestamp corresponding to receipt/generation of the actual email received at the archive.

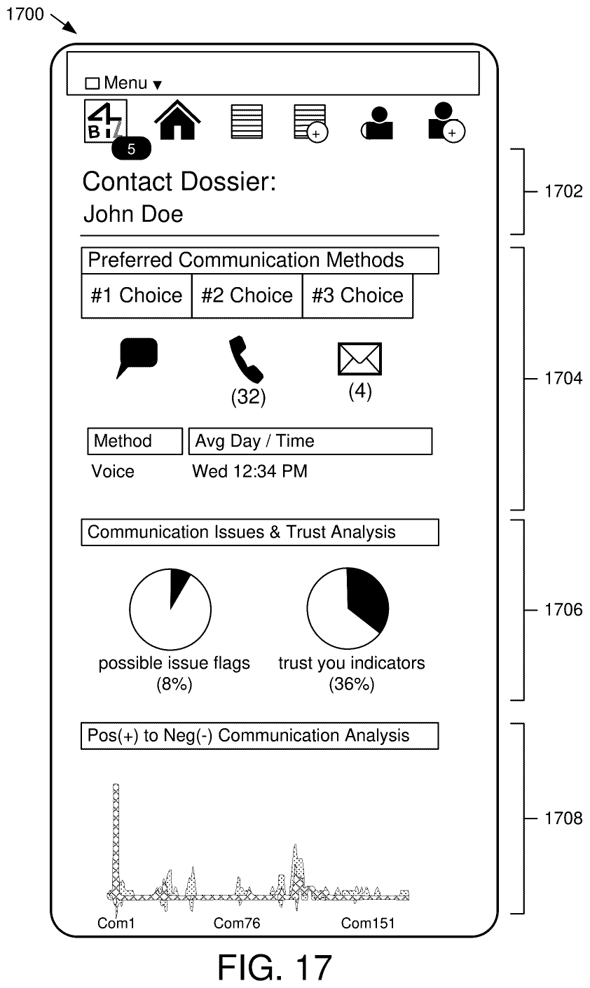

FIG. 17 depicts a user interface showing a reporting suite 1700 for a collection of communications, according to embodiments of the disclosure. In the depicted embodiment, the reporting suite 1700 includes a contact dossier comprising contact information 1702 of a communication peer linked to the collection, preferred communication types 1704 of the communication peer, interaction issues and/or trust analysis 1706, and a positive-to-negative communication analysis 1708 of the communications within the collection.

In some embodiments, the contact information 1702 includes a name of the communication peer. The contact information 1702 may contain additional information including phone numbers, email addresses, chat names, usernames, or other identifier associated with a particular communication method or communication type.

In some embodiments, the preferred communication types 1704 of the contact/communication peer indicate a particular communication type/channel most used by the contact/communication peer. Additionally, the preferred communication types 1704 may indicate a typical communication time and/or day for a preferred communication type, e.g., determined by averaging timestamp data.

In certain embodiments, the reporting suite 1700 may display the most-popular communication types, along with a message/communication count (i.e., usage data) for each communication type. In the depicted embodiment, the preferred communication types 1704 profiles, e.g., a first choice: text message (41), second choice: voice call (32), third choice: email (4) can be derived from two or more parties communicating using this system, applicable to individual contacts, contact groups and collaborating groups. Any communication type captured may added to the report.

In the depicted embodiment, the usage data associated with the preferred communication types 1704 indicates that text messaging (e.g., SMS or MMS) is preferred over voice calls by a small margin, while text messaging and voice calls are both preferred over email communication by a large margin. These metrics may be drilled down further to obtain details like best time of day, best days and this data may be filtered by date range and related times.

In certain embodiments, the reporting suite 1700 may export (or sync) the communication preference data to automate the creation of dialing lists, sending email and text messages (in a time release queue based on preferred communications time of contacts, where different times can be programmatically set based on the communication type and data set provided by this system) for entities making outbound sales, telemarketing, customer service and support calls.

In certain embodiments, the preferred communication types 1704 report requires communications to be archived in order to be output, and naturally as more data is accumulated the results are subject to change and accuracy may increase.

In various embodiments, the reporting suite 1700 may support emotion and/or character profiling. For example, the reporting suite 1700 may display graphs, charts, text, etc. containing reports that detail information regarding problems/negative interactions and positive interactions. In some embodiments, the interaction issues and/or trust analysis 1706 identifies “possible issue flags” (i.e., denoting problems/negative queues that arose from itemized or combined categories of communications) and “trust you indicators” (i.e., denoting positive trust queues that arose from itemized or combined categories of communications), relating to the collection. In the depicted embodiment, the reporting suite 1700 shows the ratio of “possible issue flags” and “trust you indicators”, e.g., as a percentage of the overall communications. Note that issue flags and trust indicators may also be applied to itemized communications, e.g., as shown in FIGS. 14A-14C.

In various embodiments, the reporting suite 1700 may display data showing ratings between contact groups and/or individual contacts interacting with the system user. In certain embodiments, the displayed data may be selectable to drill down further to actual incidents of one or more communications that are associated to the reporting data. In certain embodiments, the displayed data may also be expanded to itemize the full range of emotions, where a positive queue could then be drilled down to see results as it pertains to joy and trust ratings, and negative queues might contain anger, sadness, fear, and disgust ratings.

In some embodiments, a report may also detail a system user's performance, and this can be independently calculated from their data alone or by pooling data and generating reports for example across an entire vertical or horizontal.

In some embodiments, the positive-to-negative communication analysis 1708 denotes a comparison of both positive and negative queues that span across entire itemized or combined categories and their communications. In the depicted example, the positive-to-negative communication analysis 1708 is presented as a timeline with a vertical axis denoting a number of positive/negative flags (or a strength of positive/negative issues) and a horizontal axis showing the number of communications (i.e., over time). Moreover, different visual distinguishers—such as color—may be used to contrast positive queues with negative queues.

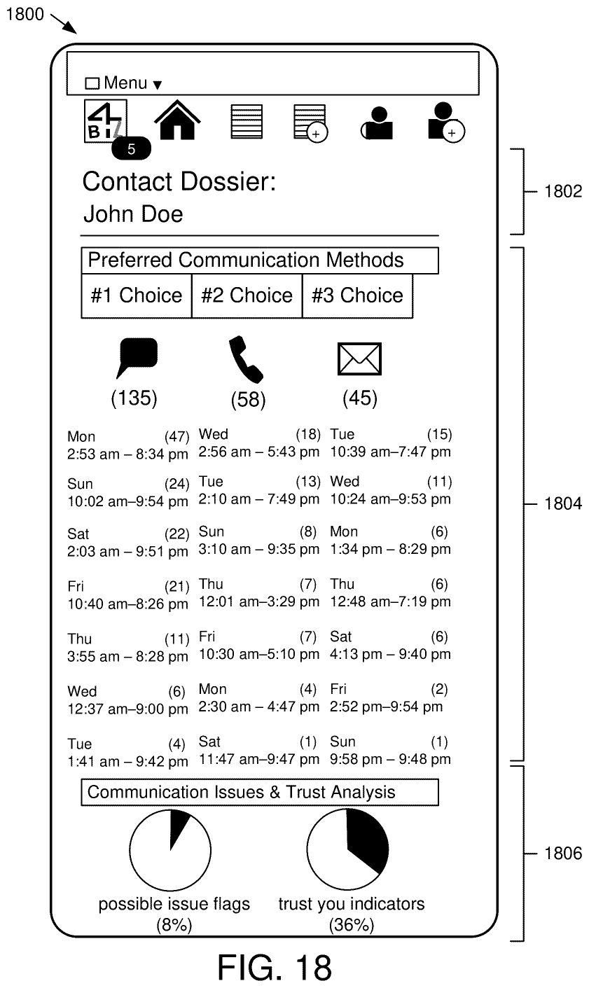

FIG. 18 is a diagram illustrating another embodiment of a reporting suite associated with a collection of communications. In the depicted embodiment, the reporting suite 1800 includes a contact dossier comprising contact information 1802 of a communication peer linked to the collection, preferred communication types 1804 of the communication peer, interaction issues and/or trust analysis 1806. The contact dossier comprising contact information 1802 and the communication peer, interaction issues and/or trust analysis 1806 are the same as those 1702, 1706 of the reporting suite of FIG. 17. The preferred communication types 1804 is expanded to depict communications for each of seven previous days where the preferred communication types were received with a summary of at the top.

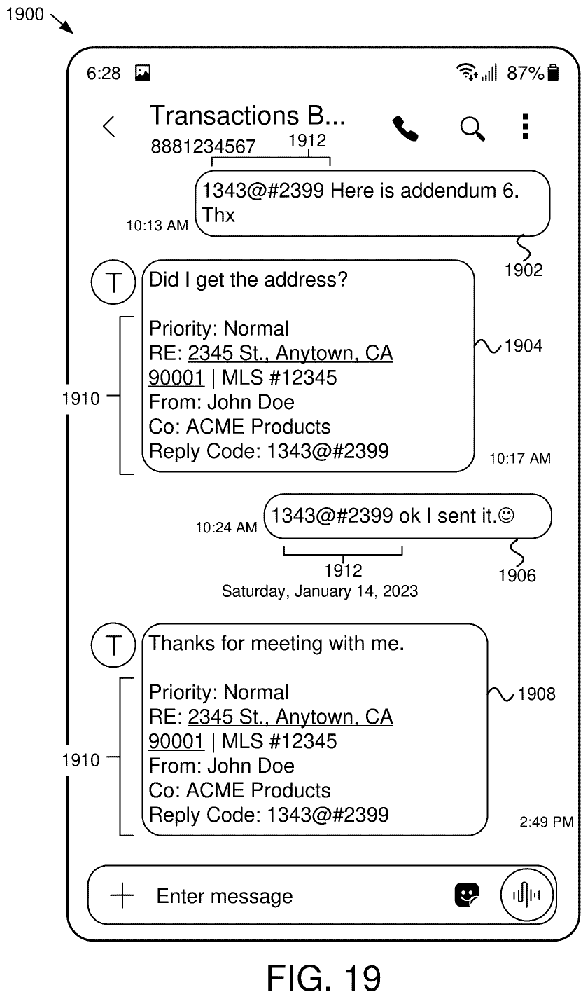

FIG. 19 depicts a screenshot of a user interface 1900 showing reply codes for text messaging, according to embodiments of the disclosure. The user interface 1900 shows a plurality of text messages 1902, 1904, 1906, 1908 between an authorized system user 622 and a contact/communication peer 626. Here, it is assumed that the user interface 1900 is displayed on a device of the contact/communication peer 626 and that the contact/communication peer 626 is not using a system/UCN application to send and receive text messages.

In some embodiments, collection information 1910 is automatically added by the UCN to each outgoing text message sent by the authorized system user 622. Included in the collection information 1910 is a reply code 1912 (also referred to as a “routing code”) that uniquely identifies a collection. In the depicted embodiment, the reply code is “1343@#2399”.

In some embodiments, the contact/communication peer 626 adds the reply code 1912 (e.g., manually or automatically) to each reply text message. This ensures that all text messages 1902, 1904, 1906, 1908 are identified as part of the collection corresponding to the reply code 1912.

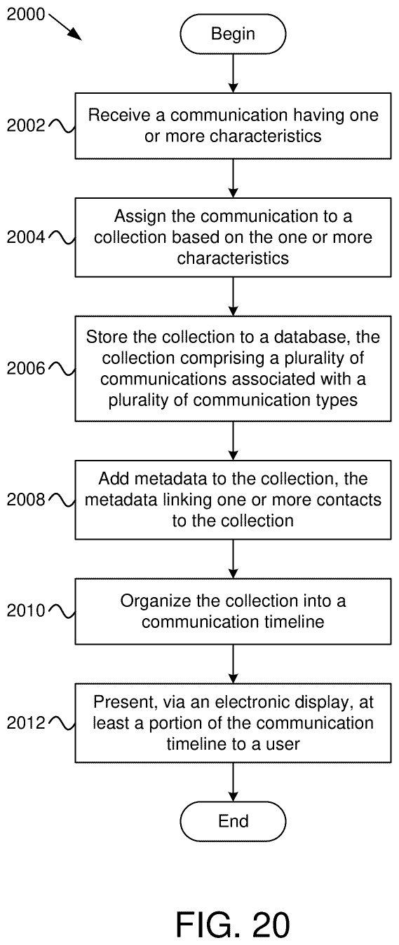

FIG. 20 is a flowchart diagram illustrating one embodiment of a method 2000 for collating and selectively presenting communications, according to embodiments of the disclosure. In various embodiments, the method 2000 is performed by a networked communication device, such as the server 106, the UCN 602, and/or the UCN control software 606, as described above. In some embodiments, the method 2000 is performed by a processor, such as a microcontroller, a microprocessor, a Central Processing Unit (“CPU”), a Graphic Processing Unit (“GPU”), an auxiliary processing unit, a FPGA, or the like.

The method 2000 begins and receives 2002 a communication having one or more characteristics. The method 2000 includes assigning 2004 the communication to a collection based on the one or more characteristics. The method 2000 includes storing 2006 the collection to a database, the collection comprising a plurality of communications associated with a plurality of communication types. The method 2000 includes adding 2008 metadata to the collection, the metadata linking one or more contacts to the collection. The method 2000 includes organizing 2010 the collection into a communication timeline. The method 2000 includes presenting 2012, via an electronic display, at least a portion of the communication timeline to a user. The method 2000 ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a processor; and
a non-transitory computer readable storage medium storing code, the code being executable by the processor to perform operations comprising:
receiving a communication having one or more characteristics;
assigning the communication to a collection based on the one or more characteristics;
storing the collection to a database, the collection comprising a plurality of communications associated with a plurality of communication types;
adding metadata to the collection, the metadata linking one or more contacts to the collection;
organizing the collection into a communication timeline; and
presenting, via an electronic display, at least a portion of the communication timeline to a user.

2. The apparatus of claim 1, the operations further comprising applying a machine learning model to perform an emotion analysis of the communication and transmitting a notification to the user based on the emotion analysis.

3. The apparatus of claim 1, the operations further comprising applying a machine learning model to perform an emotion analysis of the collection, wherein presenting, via the electronic display, the at least a portion of the communication timeline to the user comprises presenting at least one trust indicator based on the emotion analysis of the collection.

4. The apparatus of claim 1, wherein presenting, via the electronic display, at least a portion of the communication timeline to the user comprises presenting, via the electronic display, an expandable view of each communication in a presented portion of the communication timeline.

5. The apparatus of claim 1, the operations further comprising:
receiving, via a user interface, one or more comments from the user regarding a respective communication in the presented portion of the communication timeline;
storing, in the database, the one or more comments; and
adding metadata to the collection linking the one or more comments to the collection.

6. The apparatus of claim 1, the operations further comprising allocating a set of direct inward dialing (“DID”) numbers to the user, wherein the collection is associated with a particular DID number of the set of DID numbers, and wherein assigning the communication to the collection is based on the communication being associated with the particular DID number.

7. The apparatus of claim 6, wherein the particular DID number is shared by a plurality of users.

8. The apparatus of claim 1, the operations further comprising converting a subset of the collection to a set of emails for delivery to a specific email address.

9. The apparatus of claim 8, wherein converting the subset of the collection to a set of emails comprises:
identifying a communication type for each communication in the subset;
generating an email comprising each communication in the subset, the email having a subject field; and
inserting an identifier corresponding to the respective communication type into the subject field of each generated email.

10. The apparatus of claim 8, the operations further comprising adding originator information to each email of the set of emails.

11. The apparatus of claim 1, the operations further comprising:
identifying a communication peer associated with the communication;
determining that the communication peer has authorized communication recording;
recording the communication;
storing the recording to the database; and
transmitting the recording of the communication to the user.

12. The apparatus of claim 1, the operations further comprising determining a set of routing parameters for each linked contact associated with the collection.

13. The apparatus of claim 1, the operations further comprising determining a preferred communication type for at least one linked contact based on the collection.

14. The apparatus of claim 1, wherein assigning the communication to the collection based on the one or more characteristics comprises determining whether the communication belongs to an existing collection based on shared characteristics and generating a new collection in response to the communication not belonging to an existing collection.

15. The apparatus of claim 14, wherein determining whether the communication belongs to an existing collection comprises comparing the one or more characteristics of the communication to one or more characteristics of the existing collection, said characteristics comprising an identity of the user, a contact associated with the communication, a routing code, or a combination thereof.

16. The apparatus of claim 1, wherein the collection is automatically defined without user input and corresponds to one of: a project, a transaction, a collaboration, or a combination thereof.

17. The apparatus of claim 16, wherein the collection comprises a plurality of communications, including one or more of: a telephone call, a voice call, a video call, a text message, an email, a Voice over Internet Protocol (“VOIP”) call, a chat session, a real-time communication (“RTC”), or a combination thereof.

18. The apparatus of claim 1, wherein presenting, via the electronic display, at least a portion of the communication timeline to a user comprises:
identifying a set of attachments, each attachment associated with a particular communication contained within the collection; and
presenting the set of attachments to the user, wherein the set of attachments comprises one or more of: a computer file, a document, an image, a video recording, an audio recording, or a combination thereof.

19. The apparatus of claim 1, wherein the received communication is an inbound communication, and the operations further comprise appending collection information to the inbound communication prior to delivery to the user.

20. A method comprising:
receiving a communication having one or more characteristics;
assigning the communication to a collection based on the one or more characteristics;
storing the collection to a database, the collection comprising a plurality of communications associated with a plurality of communication types;
adding metadata to the collection, the metadata linking one or more contacts to the collection;
organizing the collection into a communication timeline; and
presenting, via an electronic display, at least a portion of the communication timeline to a user.

21. A program product comprising a non-transitory computer readable storage medium storing code, the code being configured to be executable by a processor to perform operations comprising:
receiving a communication having one or more characteristics;
assigning the communication to a collection based on the one or more characteristics;
storing the collection to a database, the collection comprising a plurality of communications associated with a plurality of communication types;
adding metadata to the collection, the metadata linking one or more contacts to the collection;
organizing the collection into a communication timeline; and
presenting, via an electronic display, at least a portion of the communication timeline to a user.
